(19) United States
(12) Patent Application Publication
(10) Pub. No.: US 2020/0071498 A1
(43) Pub. Date: Mar. 5, 2020

(54) RESIN COMPOSITION AND RESIN MOLDED ARTICLE

(71) Applicant: FUJI XEROX CO., LTD., Tokyo (JP)

(72) Inventors: Kenji YAO, Minamiashigara-shi (JP); Kana MIYAZAKI, Minamiashigara-shi (JP); Ryo TANAKA, Minamiashigara-shi (JP)

(73) Assignee: FUJI XEROX CO., LTD., Tokyo (JP)

(21) Appl. No.: 16/256,326

(22) Filed: Jan. 24, 2019

(30) Foreign Application Priority Data
Aug. 31, 2018 (JP) 2018-164059

(51) Int. Cl. C08L 1/14; C08K 5/11; C08K 5/101; C08K 5/13; C08L 33/10; C08L 23/02; B29C 45/00

(52) U.S. Cl. CPC C08L 1/14; C08K 5/11; C08K 5/101; C08K 5/13; B29K 2001/14; C08L 23/02; B29C 45/0001; C08L 2207/53; C08L 33/10

(57) ABSTRACT

Provided is a resin composition, containing a resin having biomass-derived carbon atoms, wherein a ratio (F⁷/F¹⁴) of a bending creep elastic modulus F⁷ to a bending creep elastic modulus F¹⁴ is 1.9 to 6.0. The F⁷ is measured under conditions of a temperature of 60° C. and a load of 7 MPa for 1,000 hours, and the F¹⁴ is measured under conditions of a temperature of 60° C. and a load of 14 MPa for 1,000 hours, in accordance with a method specified in ISO 899-2: 1993.

### CROSS-REFERENCE TO RELATED APPLICATIONS

This application is based on and claims priority under 35 USC 119 from Japanese Patent Application No. 2018-164059 filed on Aug. 31, 2018.

### BACKGROUND

### Technical Field

The present invention relates to a resin composition and a resin molded article.

### Related Art

Conventionally, resin compositions have been provided and used for various purposes. Particularly, the resin compositions are used for various parts and casings of household electric appliances and automobiles. In addition, thermoplastic resin is also used for parts such as office equipment and casings of electronic and electrical equipment. In recent years, resins derived from biomass (an organic resource derived from a living thing except a fossil resource) are used, and examples of one of the resins having biomass-derived carbon atoms conventionally known include cellulose acylate.

Examples of conventional resin compositions or molding materials include those described in the following JP-A-2013-079319, JP-A-2011-132438, and JP-A-2006-282950.

JP-A-2013-079319 discloses a resin composition containing a cellulose ester (A), a styrene-based resin (B) and titanium dioxide (C), wherein the content of the component (A) is 95 mass % to 50 mass %, the content of the component (B) is 50 mass % to 5 mass %, the content of the component (C) is 0.1 part by mass to 10 parts by mass per 100 parts by mass of the total amount of the component (A) and the component (B), and a compatibilizer of the component (A) and the component (B) is not contained.

JP-A-2011-132438 discloses a molding material containing: a cellulose derivative containing at least one group in which a hydrogen atom of a hydroxyl group contained in the cellulose is substituted with A) below and at least one group substituted with the following B); and a polyhydroxyalkanoic acid having a molecular weight of 10000 or more.

A) Hydrocarbon group: —R^{A}

B) Acyl group: —CO—R^{B} (R^{B} represents a hydrocarbon group.)

JP-A-2006-282950 discloses a polyamide resin composition containing: (A) 100 parts by weight of a polyundecanamide (polyamide 11) and/or a polydodecanamide (polyamide 12) having a terminal amide group concentration of 15 (μeq per 1 g polymer); and (B) 0.05 part by weight to 1.0 part by weight of N,N-carbonylbislactam represented by the following general formula (I), wherein a relative viscosity (in 96% sulfuric acid, polymer concentration 10 g/dm³, 25° C.) measured according to JIS K-6920 is 2.3 to 3.0.

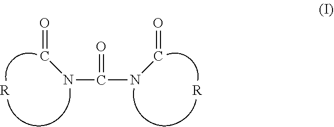

In the formula, each R represents an alkyl group, which may be the same as or different from each other.

### SUMMARY

Aspects of non-limiting embodiments of the present disclosure relate to provide a resin composition, from which a resin molded article excellent in puncture impact strength may be obtained, compared with a case where a ratio (F⁷/F¹⁴) of a bending creep elastic modulus F⁷ to a bending creep elastic modulus F¹⁴ is less than 1.9 or more than 6.0 in a resin composition containing a resin having biomass-derived carbon atoms, the F⁷ being measured under conditions of a temperature of 60° C. and a load of 7 MPa for 1,000 hours and the F¹⁴ being measured under conditions of a temperature of 60° C. and a load of 14 MPa for 1,000 hours, in accordance with a method specified in ISO 899-2:1993 in the resin composition.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a resin composition, containing a resin having biomass-derived carbon atoms, wherein a ratio (F⁷/F¹⁴) of a bending creep elastic modulus F⁷ to a bending creep elastic modulus F¹⁴ is 1.9 to 6.0, the F⁷ being measured under conditions of a temperature of 60° C. and a load of 7 MPa for 1,000 hours and the F¹⁴ being measured under conditions of a temperature of 60° C. and a load of 14 MPa for 1,000 hours, in accordance with a method specified in ISO 899-2:1993.

### BRIEF DESCRIPTION OF DRAWINGS

Exemplary embodiment(s) of the present invention will be described in detail based on the following figures, wherein:

FIG. 1A is a schematic view of a tubular test piece A, which is a resin molded article molded using resin compositions of Example and Comparative Example;

FIG. 1B is a schematic view of a cylindrical test piece B, which is a resin molded article molded using resin compositions of Example and Comparative Example; and

FIG. 2 is a schematic view showing an example of assembling and disassembling a molded article of the tubular test piece A and the cylindrical test piece B molded using resin compositions of Example and Comparative Example.

### DESCRIPTION OF REFERENCE NUMERALS

| | |
|---|---|
| A | tubular test piece |
| B | cylindrical test piece |
| F | detaching force |

### DETAILED DESCRIPTION

Hereinafter, an exemplary embodiment which is an example of the present invention is described. These descriptions and examples are illustrative of the exemplary embodiments and do not limit the scope of the exemplary embodiments.

In the numerical ranges described in the exemplary embodiment in stages, the upper limit value or the lower limit value described in one numerical range may be replaced by the upper limit value or the lower limit value of the numerical range of another numerical range. In addition, in the numerical range described in the exemplary embodiment, the upper limit value or the lower limit value of the numerical value range may be replaced by the values shown in the examples.

In the exemplary embodiment, the term “step” is not only an independent step but also included in the terms of the present disclosure as long as the intended purpose of the step is achieved even when it cannot be clearly distinguished from other steps.

In the exemplary embodiment, each component may contain a plurality of corresponding substances. In the exemplary embodiment, in a case of referring to the amount of each component in a composition, it means the total amount of the plurality of kinds of substances present in the composition when there are a plurality of kinds of substances corresponding to each component in the composition, unless otherwise specified.

In the exemplary embodiment, “(meth)acryl” means at least one of acryl and methacryl, and “(meth)acrylate” means at least one of acrylate and methacrylate.

In the exemplary embodiment, the cellulose acylate (A), the ester compound (B), the plasticizer (C) and the thermoplastic elastomer (D) are also referred to as component (A), component (B), component (C) and component (D), respectively.

### <Resin Composition>

The resin composition according to the exemplary embodiment contains a resin having biomass-derived carbon atoms, wherein a ratio (F⁷/F¹⁴) of a bending creep elastic modulus r to a bending creep elastic modulus r⁴ is 1.9 to 6.0, the r being measured under the conditions of a temperature of 60° C. and a load of 7 MPa for 1,000 hours and the r⁴ being measured under the conditions of a temperature of 60° C. and a load of 14 MPa for 1,000 hours, in accordance with a method specified in ISO 899-2:1993.

The resin composition according to the exemplary embodiment may contain other components such as an ester compound (B), a plasticizer (C), and a thermoplastic elastomer (D) which will be described later.

Unlike a resin composition derived from a fossil resource such as petroleum, it is difficult to freely design a molecular structure for a resin composition containing a conventional biomass-derived component, and it is difficult to impart desired properties, so the puncture impact strength of the resin molded article may be insufficient.

With respect to this, the resin composition according to the exemplary embodiment contains a resin having biomass-derived carbon atoms, wherein a ratio (F⁷/F¹⁴) of a bending creep elastic modulus F⁷ to a bending creep elastic modulus F¹⁴ is 1.9 to 6.0, the r being measured under the conditions of a temperature of 60° C. and a load of 7 MPa for 1,000 hours and the F¹⁴ being measured under the conditions of a temperature of 60° C. and a load of 14 MPa for 1,000 hours, in accordance with a method specified in ISO 899-2:1993. Thus, a resin molded article excellent in puncture impact strength may be obtained. The reasons for this are presumed as follows.

It is presumed that the ratio (F⁷/F¹⁴) of the bending creep elastic modulus F⁷ to the bending creep elastic modulus F¹⁴ of 1.9 or more indicates that the intermolecular force in the resin composition is weak, the r being measured under the conditions of a temperature of 60° C. and a load of 7 MPa for 1,000 hours and the F¹⁴ being measured under the conditions of a temperature of 60° C. and a load of 14 MPa for 1,000 hours, in accordance with a method specified in ISO 899-2:1993 in the resin composition; when an external force due to a collision at a high speed is received, the molecules are pulled apart and the resin molded article may be broken.

In addition, it is presumed that F⁷/F¹⁴ of 6.0 or less indicates that the elastic modulus is high even when a load is applied for a certain period of time, and the resin deforms against an external force, may not be sufficient to absorb energy and is thus vulnerable to puncture impact. In addition, it is presumed that when the F⁷/F¹⁴ is 1.9 to 6.0, it is considered that the load dependence is considered to be somewhat a large design, which supports the acceleration of the energy absorption quickly; within this value range, the puncture impact strength is improved without excessively deforming and without reducing energy absorption.

From the above reasons, it is considered that the resin molded article obtained from the resin composition in the exemplary embodiment is excellent in puncture impact strength.

### [Bending Creep Elastic Modulus]

The resin composition according to the exemplary embodiment has a ratio (F⁷/F¹⁴) of a bending creep elastic modulus F⁷ to a bending creep elastic modulus F¹⁴ of 1.9 to 6.0, the F⁷ being measured under the conditions of a temperature of 60° C. and a load of 7 MPa for 1,000 hours and the F¹⁴ being measured under the conditions of a temperature of 60° C. and a load of 14 MPa for 1,000 hours, in accordance with a method specified in ISO 899-2:1993. From the viewpoint of obtaining puncture impact strength in the obtained resin molded article, the ratio is preferably 1.9 to 5.0, more preferably 2.0 to 4.0, still more preferably 2.1 to 3.0, and particularly preferably 2.2 to 2.8.

The values of r and F¹⁴ are adjusted based on, for example, the type and content of the resin contained in the resin composition, the type and content of the ester compound (B) described later, and the type and content of the plasticizer (C) described later.

The bending creep elastic modulus of the resin composition in the exemplary embodiment is measured by the following method.

An ISO multipurpose dumbbell test piece (corresponding to ISO 527 tensile test and ISO 178 bending test, test part having a thickness of 4 mm and a width of 10 mm) is molded using the resin composition according to the exemplary embodiment at an cylinder temperature at which the injection peak pressure does not exceed 180 MPa by an injection molding machine (NEX500, manufactured by NISSEI PLASTIC INDUSTRIAL CO., LTD.).

The obtained ISO multipurpose dumbbell test piece is subjected to a test according to ISO 899-2:1993 using a universal testing apparatus (Autograph AG-X plus, manufactured by

Shimadzu Corporation) under the conditions of a temperature of 60° C., and a load of 7 MPa or 14 MPa for 1,000 hours, so as to the measure bending creep elastic modulus.

In the resin composition according to the exemplary embodiment, the bending creep elastic modulus F⁷ measured under the conditions of a temperature of 60° C. and a load of 7 MPa for 1,000 hours in accordance with a method specified in ISO 899-2:1993 is preferably 1,200 MPa to 1,800 MPa, more preferably 1,300 MPa to 1,750 MPa, and still more preferably 1,350 MPa to 1,650 MPa, from the viewpoint of obtaining puncture impact strength in the obtained resin molded article.

In the resin composition according to the exemplary embodiment, the bending creep elastic modulus F¹⁴ measured under the conditions of a temperature of 60° C. and a load of 14 MPa for 1,000 hours in accordance with a method specified in ISO 899-2:1993 is preferably 200 MPa to 800 MPa, more preferably 300 MPa to 750 MPa, and still more preferably 450 MPa to 700 MPa, from the viewpoint of obtaining puncture impact strength in the obtained resin molded article.

Hereinafter, the components of the resin composition according to the exemplary embodiment are described in detail.

### [Resin Having Biomass-Derived Carbon Atom]

The resin composition according to the exemplary embodiment contains a resin having biomass-derived carbon atoms.

The resin having biomass-derived carbon atoms is not particularly limited, and a known resin having biomass-derived carbon atoms is used.

Further, the resin having biomass-derived carbon atoms may not necessarily be entirely derived from biomass as long as at least a part thereof has a biomass-derived structure. Specifically, for example, as the cellulose acylate to be described later, the cellulose structure may be derived from biomass and the acylate structure may be derived from petroleum.

The “resin having biomass-derived carbon atoms” in the exemplary embodiment is a resin having at least carbon atoms derived from organic resources derived from living things excluding fossil resources, and as described later, based on the provisions of ASTM D6866:2012, the presence of biomass-derived carbon atoms is indicated by the abundance of ¹⁴C.

The content of the biomass-derived carbon atom in the resin composition according to the exemplary embodiment defined in ASTM D6866:2012 is preferably 20% or more, more preferably 30% or more, still more preferably 35% or more, and particularly preferably 40% to 100% based on a total amount of carbon atoms in the resin composition, from the viewpoint of obtaining puncture impact strength in the obtained resin molded article.

In the exemplary embodiment, the method for measuring the content of the biomass-derived carbon atom in the resin composition includes measuring the content of ¹⁴C in the total amount of carbon atoms in the resin composition, and calculating the content of the biomass-derived carbon atoms based on the provisions of ASTM D6866:2012.

Examples of the resin having biomass-derived carbon atoms include a cellulose acylate, a polylactic acid, a biomass-derived polyolefin, biomass-derived polyethylene terephthalate, a biomass-derived polyamide, poly(3-hydroxybutyric acid), polytrimethylene terephthalate (PTT), polybutylene succinate (PBS), phosphatidyl glycerol (PG), an isosorbide polymer, an acrylic acid modified rosin or the like.

Of those, the resin having biomass-derived carbon atoms preferably contains a cellulose acylate (A), and more preferably is a cellulose acylate (A), from the viewpoint of obtaining puncture impact strength in the obtained resin molded article.

### —Cellulose Acylate (A): Component (A)—

The cellulose acylate (A) is a cellulose derivative in which at least a part of hydroxyl groups in the cellulose are substituted (acylated) with an acyl group. The acyl group is a group having a structure of —CO—R^{AC} (R^{AC} represents a hydrogen atom or a hydrocarbon group).

The cellulose acylate (A) is, for example, a cellulose derivative represented by the following General Formula (CA).

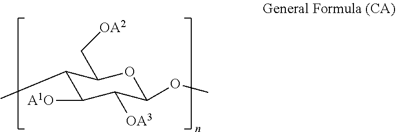

In the General Formula (CA), A¹, A² and A³ each independently represent a hydrogen atom or an acyl group, and n represents an integer of 2 or more. However, at least a part of n A¹, n A² and n A³ represents an acyl group. All of n A¹ in the molecule may be the same, partly the same or different from each other. Similarly, all of n A² and n A³ in the molecule may be the same, partly the same or different from each other.

The hydrocarbon group in the acyl group represented by A¹, A² and A³ may be linear, branched or cyclic, and is preferably linear or branched, and more preferably linear.

The hydrocarbon group in the acyl group represented by A¹, A² and A³ may be a saturated hydrocarbon group or an unsaturated hydrocarbon group, and more preferably a saturated hydrocarbon group.

The acyl group represented by A¹, A² and A³ is preferably an acyl group having 1 to 6 carbon atoms. That is, the cellulose acylate (A) preferably has an acyl group with 1 to 6 carbon atoms. A resin molded article having excellent puncture impact strength may be more easily obtained from the cellulose acylate (A) having an acyl group with 1 to 6 carbon atoms, than from a cellulose acylate (A) having an acyl group with 7 or more carbon atoms.

The acyl group represented by A¹, A² and A³ may be a group in which a hydrogen atom in the acyl group is substituted with a halogen atom (e.g., a fluorine atom, a bromine atom and an iodine atom), an oxygen atom, a nitrogen atom or the like, and is preferably unsubstituted.

Examples of the acyl group represented by A¹, A² and A³ include a formyl group, an acetyl group, a propionyl group, a butyryl group (a butanoyl group), a propenoyl group, and a hexanoyl group. Of these, the acyl group is preferably an acyl group having 2 to 4 carbon atoms, and more preferably an acyl group having 2 or 3 carbons, from the viewpoints of obtaining moldability of the resin composition and puncture impact strength of the resin molded article.

Examples of the cellulose acylate (A) include a cellulose acetate (cellulose monoacetate, cellulose diacetate (DAC), and cellulose triacetate), a cellulose acetate propionate (CAP), and a cellulose acetate butyrate (CAB).

The cellulose acylate (A) is preferably cellulose acetate propionate (CAP) and cellulose acetate butyrate (CAB), and more preferably cellulose acetate propionate (CAP), from the viewpoint of obtaining puncture impact strength in the obtained resin molded article.

The cellulose acylate (A) may be used alone, or may be used in combination of two or more thereof.

The cellulose acylate (A) preferably has a wight-average polymerization degree of 200 to 1000, and more preferably 600 to 1000 from the viewpoints of obtaining moldability of the resin composition and puncture impact strength in the obtained resin molded article.

The weight-average polymerization degree of the cellulose acylate (A) is determined from the weight average molecular weight (Mw) by the following procedures.

First, the weight average molecular weight (Mw) of the cellulose acylate (A) is measured in terms of polystyrene by a gel permeation chromatography apparatus (GPC apparatus: HLC-8320 GPC manufactured by Tosoh Corporation, column: TSK gel a-M) using tetrahydrofuran.

Subsequently, the polymerization degree of the cellulose acylate (A) is determined by dividing by the structural unit molecular weight of the cellulose acylate (A). For example, in a case where the substituent of the cellulose acylate is an acetyl group, the structural unit molecular weight is 263 when the degree of substitution is 2.4 and is 284 when the degree of substitution is 2.9.

The weight average molecular weight (Mw) of the resin in the exemplary embodiment is also measured by the same method as the method for measuring the weight average molecular weight of the cellulose acylate (A).

The cellulose acylate (A) preferably has a degree of substitution of 2.1 to 2.9, more preferably 2.2 to 2.9, still more preferably 2.3 to 2.9, and particularly preferably 2.6 to 2.9, from the viewpoints of obtaining moldability of the resin composition and puncture impact strength in the obtained resin molded article.

In the cellulose acetate propionate (CAP), a ratio of the degree of substitution of the acetyl group to the propionyl group (acetyl group/propionyl group) is preferably 0.01 to 1, and more preferably 0.05 to 0.1, from the viewpoints of obtaining moldability of the resin composition and puncture impact strength in the obtained resin molded article.

The CAP preferably satisfies at least one of the following (1), (2), (3) and (4), more preferably satisfies the following (1), (3) and (4), and still more preferably satisfies the following (2), (3) and (4). (1) When measured by the GPC method using tetrahydrofuran as a solvent, the weight average molecular weight (Mw) in terms of polystyrene is 160,000 to 250,000, and a ratio Mn/Mz of a number average molecular weight (Mn) in terms of polystyrene to a Z average molecular weight (Mz) in terms of polystyrene is 0.14 to 0.21. (2) When measured by the GPC method using tetrahydrofuran as a solvent, the weight average molecular weight (Mw) in terms of polystyrene is 160,000 to 250,000, a ratio Mn/Mz of a number average molecular weight (Mn) in terms of polystyrene to a Z average molecular weight (Mz) in terms of polystyrene is 0.14 to 0.21, and a ratio Mw/Mz of a weight average molecular weight (Mw) in terms of polystyrene to the Z average molecular weight (Mz) in terms of polystyrene is 0.3 to 0.7. (3) When measured with a Capirograph at a condition of 230° C. according to ISO 11443:1995, a ratio η1/η2 of a viscosity η1 (Pa·s) at a shear rate of 1216 (/sec) to a viscosity η2 (P·s) at a shear rate of 121.6 (/sec) is 0.1 to 0.3. (4) When a small square plate test piece (D11 test piece specified by JIS K7139:2009, 60 mm×60 mm, thickness 1 mm) obtained by injection molding of the CAP is allowed to stand in an atmosphere at a temperature of 65° C. and a relative humidity of 85% for 48 hours, both an expansion coefficient in an MD direction and an expansion coefficient in a TD direction are 0.4% to 0.6%. Here, the MD direction means the length direction of the cavity of the mold used for injection molding, and the TD direction means the direction orthogonal to the MD direction.

In the cellulose acetate butyrate (CAB), a ratio of degree of substitution of the acetyl group to the butyryl group (acetyl group/butyryl group) is preferably 0.05 to 3.5 from the viewpoints of obtaining moldability of the resin composition and puncture impact strength in the obtained resin molded article.

The degree of substitution of the cellulose acylate (A) is an index indicating the degree to which the hydroxyl group of cellulose is substituted with an acyl group. That is, the degree of substitution is an index indicating the degree of acylation of the cellulose acylate (A). Specifically, the degree of substitution means the intramolecular average of the number of substitution in which three hydroxyl groups in a D-glucopyranose unit of the cellulose acylate are substituted with the acyl group. The degree of substitution is determined from an integrated ratio of peaks of a cellulose-derived hydrogen atom and an acyl group-derived hydrogen atom with ¹H-NMR (JMN-ECA, manufactured by JEOL RESONANCE Co., Ltd.).

The resin having biomass-derived carbon atoms may be used alone, or may be used in combination of two or more thereof.

### [Ester Compound (B): Component (B)]

The resin composition according to the exemplary embodiment further contains at least one ester compound (B) selected from the group consisting of a compound represented by the following General Formula (1), a compound represented by the following General Formula (2), a compound represented by the following General Formula (3), a compound represented by the following General Formula (4), and a compound represented by the following General Formula (5), from the viewpoint of obtaining puncture impact strength in the obtained resin molded article.

Of these, the resin composition according to the exemplary embodiment contains, as the ester compound (B), preferably one selected from the group consisting of a compound represented by the following General Formula (1), a compound represented by the following General Formula (2) and a compound represented by the following General Formula (3), more preferably one selected from the group consisting of the compound represented by the following General Formula (1) and the compound represented by the following General Formula (2), and particularly preferably the compound represented by the following General Formula (1), from the viewpoint of obtaining puncture impact strength in the obtained resin molded article.

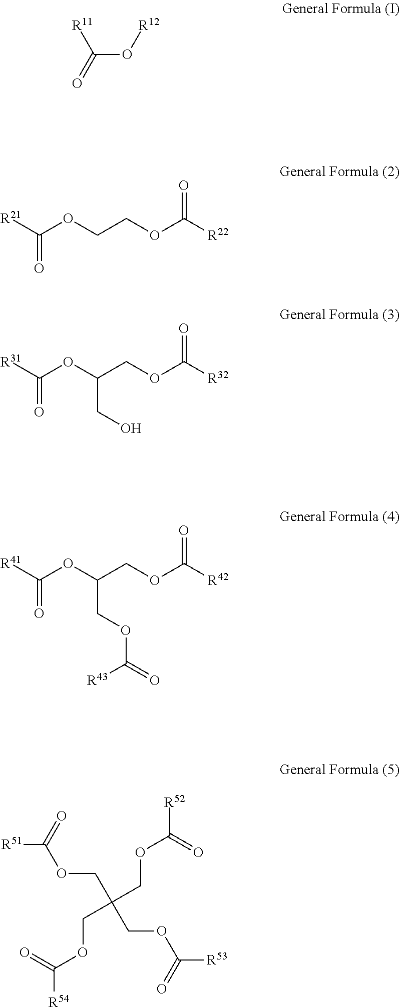

In the General Formula (1), R¹¹ represents an aliphatic hydrocarbon group having 7 to 28 carbon atoms, and R²² represents an aliphatic hydrocarbon group having 9 to 28 carbon atoms.

In the General Formula (2), R²¹ and R²² each independently represent an aliphatic hydrocarbon group having 7 to 28 carbon atoms.

In the General Formula (3), R³¹ and R³² each independently represent an aliphatic hydrocarbon group having 7 to 28 carbon atoms.

In the General Formula (4), R⁴¹, R⁴², and R⁴³ each independently represent an aliphatic hydrocarbon group having 7 to 28 carbon atoms.

In the General Formula (5), R⁵¹, R⁵², R⁵³, and R⁵⁴ each independently represent an aliphatic hydrocarbon group having 7 to 28 carbon atoms.

R¹¹ represents an aliphatic hydrocarbon group having 7 to 28 carbon atoms. The group represented by R¹¹ is preferably an aliphatic hydrocarbon group having 9 or more carbon atoms, more preferably an aliphatic hydrocarbon group having 10 or more carbon atoms, and still more preferably an aliphatic hydrocarbon group having 15 or more carbon atoms, from the viewpoint that the group easily acts as a lubricant with respect to the molecular chain of the resin. The group represented by R¹¹ is preferably an aliphatic hydrocarbon group having 24 or less carbon atoms, more preferably an aliphatic hydrocarbon group having 20 or less carbon atoms, and still more preferably an aliphatic hydrocarbon group having 18 or less carbon atoms, from the viewpoint that the group easily enters between the molecular chains of the resin (in particular, cellulose acylate (A), the same applies hereinafter). The group represented by R¹¹ is particularly preferably an aliphatic hydrocarbon group having 17 carbon atoms.

The group represented by R¹¹ may be a saturated aliphatic hydrocarbon group or an unsaturated aliphatic hydrocarbon group. The group represented by R¹¹ is preferably a saturated aliphatic hydrocarbon group from the viewpoint that the group easily enters between the molecular chains of the resin.

The group represented by R¹¹ may be a linear aliphatic hydrocarbon group, a branched aliphatic hydrocarbon group, or an aliphatic hydrocarbon group containing an alicyclic ring. The group represented by R¹¹ is preferably an aliphatic hydrocarbon group not containing an alicyclic ring (i.e., a chain aliphatic hydrocarbon group), and more preferably a linear aliphatic hydrocarbon group, from the viewpoint that the group easily enters between the molecular chains of the resin (A).

When the group represented by R¹¹ is an unsaturated aliphatic hydrocarbon group, the number of unsaturated bonds in the group is preferably 1 to 3, more preferably 1 or 2, and still more preferably 1, from the viewpoint that the group easily enters between the molecular chains of the resin.

When the group represented by R¹¹ is an unsaturated aliphatic hydrocarbon group, the group preferably contains a linear saturated hydrocarbon chain having 5 to 24 carbon atoms, more preferably a linear saturated hydrocarbon chain having 7 to 22 carbon atoms, still more preferably a linear saturated hydrocarbon chain having 9 to 20 carbon atoms, and particularly preferably a linear saturated hydrocarbon chain having 15 to 18 carbon atoms, from the viewpoint that the group easily enters between the molecular chains of the resin and easily acts as a lubricant with respect to the molecular chain of the resin.

When the group represented by R¹¹ is a branched aliphatic hydrocarbon group, the number of branched chains in the group is preferably 1 to 3, more preferably 1 or 2, and still more preferably 1, from the viewpoint that the group easily enters between the molecular chains of the resin.

When the group represented by R¹¹ is a branched aliphatic hydrocarbon group, the main chain of the group preferably has 5 to 24 carbon atoms, more preferably 7 to 22 carbon atoms, still more preferably 9 to 20 carbon atoms, and particularly preferably 15 to 18 carbon atoms, from the viewpoint that the group easily enters between the molecular chains of the resin and easily acts as a lubricant with respect to the molecular chain of the resin.

When the group represented by R¹¹ is an aliphatic hydrocarbon group containing an alicyclic ring, the number of alicyclic rings in the group is preferably 1 or 2, and more preferably 1, from the viewpoint that the group easily enters between the molecular chains of the resin.

When the group represented by R¹¹ is an aliphatic hydrocarbon group containing an alicyclic ring, the alicyclic ring in the group is preferably an alicyclic ring having 3 or 4 carbon atoms, and more preferably an alicyclic ring having 3 carbon atoms, from the viewpoint that the group easily enters between the molecular chains of the resin.

The group represented by R¹¹ is preferably a linear saturated aliphatic hydrocarbon group, a linear unsaturated aliphatic hydrocarbon group, a branched saturated aliphatic hydrocarbon group, or a branched unsaturated aliphatic hydrocarbon group, and particularly preferably a linear saturated aliphatic hydrocarbon group, from the viewpoint of further improving the puncture impact strength of the resin molded article. The preferred number of carbon atoms in these aliphatic hydrocarbon groups is as described above.

The group represented by R¹¹ may be a group in which a hydrogen atom in the aliphatic hydrocarbon group is substituted with a halogen atom (e.g., a fluorine atom, a bromine atom and an iodine atom), an oxygen atom, a nitrogen atom or the like, and is preferably unsubstituted.

R¹² represents an aliphatic hydrocarbon group having 9 to 28 carbon atoms. Examples of the group represented by R¹² include the same forms as those described for R¹¹. However, the number of carbon atoms of the group represented by R¹² preferably satisfies the followings.

The group represented by R¹² is preferably an aliphatic hydrocarbon group having 10 or more carbon atoms, more preferably an aliphatic hydrocarbon group having 11 or more carbon atoms, and still more preferably an aliphatic hydrocarbon group having 16 or more carbon atoms, from the viewpoint that the group easily acts as a lubricant with respect to the molecular chain of the resin. The group represented by R¹² is preferably an aliphatic hydrocarbon group having 24 or less carbon atoms, more preferably an aliphatic hydrocarbon group having 20 or less carbon atoms, and still more preferably an aliphatic hydrocarbon group having 18 or less carbon atoms, from the viewpoint that the group easily enters between the molecular chains of the resin. The group represented by R¹² is particularly preferably an aliphatic hydrocarbon group having 18 carbon atoms.

The group represented by R¹² is preferably a linear saturated aliphatic hydrocarbon group, a linear unsaturated aliphatic hydrocarbon group, a branched saturated aliphatic hydrocarbon group, or a branched unsaturated aliphatic hydrocarbon group, and particularly preferably a linear saturated aliphatic hydrocarbon group, from the viewpoint of further improving the puncture impact strength of the resin molded article. The preferred number of carbon atoms in these aliphatic hydrocarbon groups is as described above.

The specific forms and preferred forms of the groups represented by R²¹, R²², R³¹, R³², R⁴¹, R⁴², R⁴³, R⁵¹, R⁵², R⁵³ and R⁵⁴ are the same as those described for R¹¹.

Hereinafter, specific examples of the aliphatic hydrocarbon group having 7 to 28 carbon atoms represented by R¹¹, R²¹, R²², R³¹, R³², R⁴¹, R⁴², R⁴³, R⁵¹, R⁵², R⁵³ and R⁵⁴ and specific examples of the aliphatic hydrocarbon group having 9 to 28 carbon atoms represented by R¹² are shown, but the exemplary embodiment is not limited thereto.

R¹¹, R¹², R²¹, R²², R³¹, R³², R⁴¹, R⁴², R⁴³, R⁵¹, R⁵², R⁵³, R⁵⁴
Linear and saturated

| | | |
|---|---|---|
| —C₆H₁₂CH₃ | —C₁₂H₂₄CH₃ | —C₁₉H₃₈CH₃ |
| —C₇H₁₄CH₃ | —C₁₄H₂₈CH₃ | —C₂₀H₄₀CH₃ |
| —C₈H₁₆CH₃ | —C₁₅H₃₀CH₃ | —C₂₁H₄₂CH₃ |
| —C₉H₁₈CH₃ | —C₁₆H₃₂CH₃ | —C₂₃H₄₆CH₃ |
| —C₁₀H₂₀CH₃ | —C₁₇H₃₄CH₃ | —C₂₅H₅₀CH₃ |
| —C₁₁H₂₂CH₃ | —C₁₈H₃₆CH₃ | —C₂₇H₅₄CH₃ |

R¹¹, R¹², R²¹, R²², R³¹, R³², R⁴¹, R⁴², R⁴³, R⁵¹, R⁵², R⁵³, R⁵⁴
Linear and unsaturated

| | |
|---|---|
| —CH═CH—C₄H₈CH₃ | —C₂H₄—CH═CH—C₂H₄CH₃ |
| —CH═CH—C₆H₁₂CH₃ | —C₄H₈—CH═CH—C₄H₈CH₃ |
| —CH═CH—C₈H₁₆CH₃ | —C₅H₁₀—CH═CH—C₅H₁₀CH₃ |
| —CH═CH—C₁₄H₂₈CH₃ | —C₆H₁₂—CH═CH—C₆H₁₂CH₃ |
| —CH═CH—C₁₅H₃₀CH₃ | —C₇H₁₄—CH═CH—C₃H₆CH₃ |
| —CH═CH—C₁₆H₃₂CH₃ | —C₇H₁₄—CH═CH—C₅H₁₀CH₃ |
| —CH═CH—C₁₇H₃₄CH₃ | —C₇H₁₄—CH═CH—C₇H₁₄CH₃ |
| —CH═CH—C₁₈H₃₆CH₃ | —C₇H₁₄—CH═CH—C₈H₁₆CH₃ |
| —CH═CH—C₂₀H₄₀CH₃ | —C₇H₁₄—CH═CH—C9H₁₈CH₃ |
| —CH═CH—C₂₅H₅₀CH₃ | —C₈H₁₆—CH═CH—C₈H₁₆CH₃ |
| —C₅H₁₀—CH═CH₂ | —C₉H₁₈—CH═CH—C₅H₁₀CH₃ |
| —C₇H₁₄—CH═CH₂ | —C₉H₁₈—CH═CH—C₇H₁₄CH₃ |
| —C₁₅H₃₀—CH═CH₂ | —C₁₀H₂₀—CH═CH—C₁₂H₂₄CH₃ |
| —C₁₆H₃₂—CH═CH₂ | —C₁₀H₂₀—CH═CH—C₁₅H₃₀CH₃ |
| —C₁₇H₃₄—CH═CH₂ | —C₁₁H₂₂—CH═CH—C₇H₁₄CH₃ |
| —C₁₈H₃₆—CH═CH₂ | —C₁₂H₂₄—CH═CH—C₁₂H₂₄CH₃ |
| —C₂₁H₄₂—CH═CH₂ | —C₁₃H₂₆—CH═CH—C₇H₁₄CH₃ |
| —C₂₆H₅₂—CH═CH₂ | —CH₂—CH═CH—C₇H₁₄—CH═CH—C₇H₁₄CH₃ |
| —CH₂—CH═CH—C₃H₆CH₃ | —C₇H₁₄—CH═CH—CH₂—CH═CH—C₄H₈CH₃ |
| —CH₂—CH═CH—C₇H₁₄CH₃ | —C₇H₁₄—CH═CH—C₇H₁₄—CH═CH—C₇H₁₄CH₃ |
| —CH₂—CH═CH—C₁₀H₂₀CH₃ | —C₇H₁₄—CH═CH—C9H₁₈—CH═CH—C₇H₁₄CH₃ |
| —CH₂—CH═CH—C₁₆H₃₂CH₃ | —C₇H₁₄—CH═CH—CH₂—CH═CH—CH₂—CH═CH—CH₂CH₃ |
| —CH₂—CH═CH—C₂₄H₄₈CH₃ | —CH═CH—C₇H₁₄—CH═CH—C₇H₁₄—CH═CH—C₇H₁₄CH₃ |

R¹¹, R¹², R²¹, R²², R³¹, R³², R⁴¹, R⁴², R⁴³, R⁵¹, R⁵², R⁵³, R⁵⁴
Branched and saturated

| | |
|---|---|
| —C₅H₁₀—CH(CH₃)₂ | —CH(C₂H₅)—C₇H₁₄CH₃ |
| —C₁₀H₂₀—CH(CH₃)₂ | —CH(C₂H₅)—C₁₄H₂₈CH₃ |
| —C₁₄H₂₈—CH(CH₃)₂ | —CH(C₂H₅)—C₁₆H₃₂CH₃ |
| —C₁₅H₃₀—CH(CH₃)₂ | —CH(C₂H₅)—C₁₈H₃₆CH₃ |
| —C₁₆H₃₂—CH(CH₃)₂ | —CH(C₄H₉)—C₁₅H₃₀CH₃ |
| —C₁₇H₃₄—CH(CH₃)₂ | —CH(C₆H₁₃)—C₁₂H₂₄CH₃ |
| —C₂₀H₄₀—CH(CH₃)₂ | —CH(C₆H₁₃)—C₁₄H₂₈CH₃ |
| —C₂₅H₅₀—CH(CH₃)₂ | —CH(C₆H₁₃)—C₁₆H₃₂CH₃ |
| —C₆H₁₂—C(CH₃)₃ | —CH₂—CH(CH₃)—C₃H₆CH₃ |
| —C₁₀H₂₀—C(CH₃)₃ | —CH₂—CH(CH₃)—C₆H₁₂CH₃ |
| —C₁₄H₂₈—C(CH₃)₃ | —CH₂—CH(CH₃)—C₈H₁₆CH₃ |
| —C₁₅H₃₀—C(CH₃)₃ | —CH₂—CH(CH₃)—C₁₂H₂₄CH₃ |
| —C₁₆H₃₂—C(CH₃)₃ | —CH₂—CH(CH₃)—C₁₆H₃₂CH₃ |
| —CH(CH₃)—C₅H₁₀CH₃ | —CH₂—CH(CH₃)—C₂₀H₄₀CH₃ |
| —CH(CH₃)—C₁₀H₂₀CH₃ | —CH₂—CH(CH₃)—C₂₄H₄₈CH₃ |
| —CH(CH₃)—C₁₃H₂₆CH₃ | —CH₂—CH(C₆H₁₃)₂ |
| —CH(CH₃)—C₁₄H₂₈CH₃ | —CH₂—CH(C₆H₁₃)—C₇H₁₄CH₃ |
| —CH(CH₃)—C₁₅H₃₀CH₃ | —CH₂—CH(C₆H₁₃)—C₉H₁₈CH₃ |
| —CH(CH₃)—C₁₆H₃₂CH₃ | —CH₂—CH(C₆H₁₃)—C₁₂H₂₄CH₃ |
| —CH(CH₃)—C₁₇H₃₄CH₃ | —CH₂—CH(C₆H₁₃)—C₁₅H₃₀CH₃ |
| —CH(CH₃)—C₁₈H₃₆CH₃ | —CH₂—CH(C₈H₁₇)—C₁₉H₃₈CH₃ |
| —CH(CH₃)—C₂₂H₄₄CH₃ | —CH₂—CH(C₈H₁₇)—C₉H₁₈CH₃ |
| —CH(CH₃)—C₂₅H₅₀CH₃ | —CH₂—CH(C₁₀H₂₁)—C₁₂H₂₄CH₃ |

—C₂H₄—CH(CH₃)—C₃H₆—CH(CH₃)—C₃H₆—CH(CH₃)—C₃H₆—CH(CH₃)₂

R¹¹, R¹², R²¹, R²², R³¹, R³², R⁴¹, R⁴², R⁴³, R⁵¹, R⁵², R⁵³, R⁵⁴
Branched and unsaturated

| | |
|---|---|
| —CH═CH—C₅H₁₀—CH(CH₃)₂ | —CH₂—CH═CH—CH(CH₃)—CH₂CH₃ |
| —CH═CH—C₁₂H₂₄—CH(CH₃)₂ | —CH₂—CH═CH—CH(CH₃)—C₃H₆CH₃ |
| —CH═CH—C₁₅H₃₀—CH(CH₃)₂ | —CH₂—CH═CH—CH(CH₃)—C₇H₁₄CH₃ |
| —CH═CH—C₁₆H₃₂—CH(CH₃)₂ | —CH₂—CH═CH—CH(CH₃)—C₁₆H₃₂CH₃ |
| —CH═CH—C₁₈H₃₆—CH(CH₃)₂ | —CH₂—CH═CH—CH(CH₃)—C₂₂H₄₄CH₃ |
| —CH═CH—C₂₃H₄₆—CH(CH₃)₂ | —CH₂—CH═CH—CH₂—CH(CH₃)—CH₂CH₃ |
| —CH═CH—C₇H₁₄—C(CH₃)₃ | —CH₂—CH═CH—C₂H₄—CH(CH₃)—C₂H₄CH₃ |
| —CH═CH—C₁₂H₂₄—C(CH₃)₃ | —CH₂—CH═CH—C₂H₄—CH(CH₃)—C₄H₈CH₃ |
| —CH═CH—C₁₄H₂₈—C(CH₃)₃ | —CH₂—CH═CH—C₆H₁₂—CH(CH₃)—C₆H₁₂CH₃ |
| —CH═CH—C₁₆H₃₂—C(CH₃)₃ | —CH₂—CH═CH—C₇H₁₄—CH(CH₃)—C₇H₁₄CH₃ |
| —CH═CH—C₂₀H₄₀—C(CH₃)₃ | —CH₂—CH═CH—C₇H₁₄—CH(CH₃)—C₈H₁₆CH₃ |
| —CH═CH—CH(C₈H₁₇)₂ | —CH₂—CH═CH—CH₂—CH═CH—CH(CH₃)—C₃H₆CH₃ |
| —CH═CH—CH(C₆H₁₃)—C₇H₁₄CH₃ | —CH₂—CH═CH—CH₂—CH═CH—CH(CH₃)—C₇H₁₄CH₃ |
| —CH═CH—CH(C₆H₁₃)—C₁₁H₂₂CH₃ | —CH₂—CH═CH—CH₂—CH═CH—CH(CH₃)—C₁₆H₃₂CH₃ |
| —CH═CH—CH(C₈H₁₇)—C₉H₁₈CH₃ | —CH₂—CH═CH—CH(CH₃)—CH═CH—CH₂—C₃H₆CH₃ |
| —CH═CH—CH(C₈H₁₇)—C₁₂H₂₄CH₃ | —CH₂—CH═CH—CH(CH₃)—CH═CH—CH₂—C₇H₁₄CH₃ |
| —C₃H₆—CH═CH—C₅H₁₀—CH(CH₃)₂ | —CH₂—CH═CH—CH(C₂H₅)—CH═CH—CH₂—C₇H₁₄CH₃ |
| —C₇H₁₄—CH═CH—C₆H₁₂—CH(CH₃)₂ | —CH₂—CH═CH—CH(CH₃)—CH═CH—CH₂—C₁₆H₃₂CH₃ |
| —C₇H₁₄—CH═CH—C₇H₁₄—CH(CH₃)₂ | —CH₂—CH═CH—CH(C₂H₅)—CH═CH—CH₂—C₁₆H₃₂CH₃ |
| —C₈H₁₆—CH═CH—C₆H₁₂—CH(CH₃)₂ | —CH₂—CH═CH—CH(CH₃)—CH═CH—CH₂—C₁₉H₃₈CH₃ |
| —C₈H₁₆—CH═CH—C₇H₁₄—CH(CH₃)₂ | —CH₂—CH═CH—CH(CH₃)—CH═CH—CH(CH₃)—CH₂CH₃ |
| —CH(CH₃)—C₁₄H₂₈—CH═CH₂ | —CH₂—CH═CH—CH(CH₃)—CH═CH—CH(CH₃)—C₃H₆CH₃ |
| —CH(CH₃)—C₁₆H₃₂—CH═CH₂ | —CH₂—CH═CH—CH(CH₃)—CH═CH—CH(CH₃)—C₇H₁₄CH₃ |
| —CH(C₂H₅)—C₁₄H₂₈—CH═CH₂ | —CH₂—CH═CH—CH(C₂H₅)—CH═CH—CH(C₂H₅)—C₇H₁₄CH₃ |
| —CH(C₂H₅)—C₁₆H₃₂—CH═CH₂ | —CH₂—CH═CH—CH(CH₃)—CH═CH—CH(CH₃)—C₁₂H₂₄CH₃ |
| —CH(C₄F₉)—C₁₄H₂₈—CH═CH₂ | —CH₂—CH═CH—CH(CH₃)—CH═CH—CH(CH₃)—C₁₅H₃₀CH₃ |
| —CH(C₆H₁₃)—C₁₀H₂₀—CH═CH₂ | —CH₂—CH═CH—CH(CH₃)—CH═CH—CH(CH₃)—C₁₈H₃₆CH₃ |
| —CH(C₆H₁₃)—C₁₂H₂₄—CH═CH₂ | —C₄H₈—CH═CH—C₄H₈—CH═CH—C₄H₈—CH(CH₃)₂ |
| —CH₂—CH(C₆H₁₃)—C₇H₁₄—CH═CH₂ | —C₇H₁₄—CH═CH—C₇H₁₄—CH═CH—C₇H₁₄—CH(CH₃)₂ |

The ester compound (B) may be used alone, or may be used in combination of two or more thereof.

### [Plasticizer (C): Component (C)]

The resin composition according to the exemplary embodiment preferably further contains a plasticizer (C) from the viewpoint of obtaining puncture impact strength in the obtained resin molded article.

Examples of the plasticizer (C) include a cardanol compound, an ester compound other than the ester compound (B), camphor, a metal soap, a polyol, a polyalkylene oxide, or the like. The plasticizer (C) is preferably a cardanol compound from the viewpoint of obtaining puncture impact strength of the resin molded article.

The plasticizer (C) may be used alone, or may be used in combination of two or more thereof.

The plasticizer (C) is preferably a cardanol compound or an ester compound other than the ester compound (B) from the viewpoint of easily improving the puncture impact strength by adding the ester compound (B). Hereinafter, the cardanol compound and the ester compound suitable as the plasticizer (C) are specifically described.

### —Cardanol Compound—

The cardanol compound refers to a component (e.g., a compound represented by the following structural formulas (c-1) to (c-4)) contained in a compound naturally derived from cashews or a derivative derived from the above components.

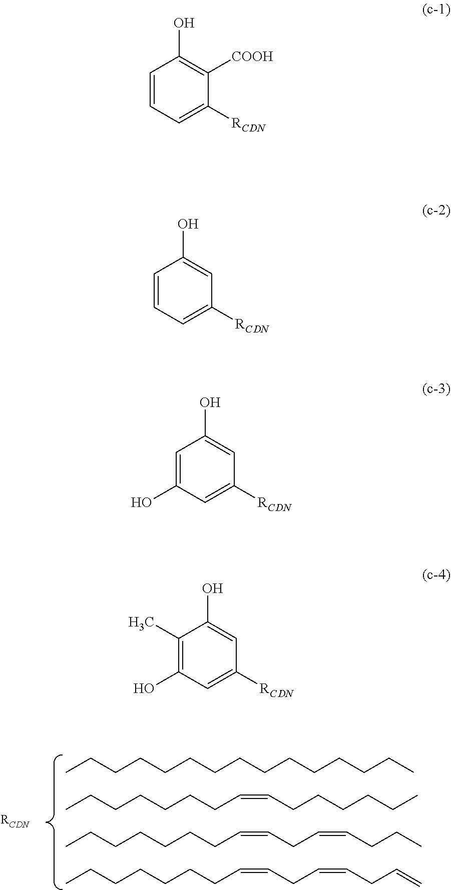

The cardanol compound may be used alone, or may be used in combination of two or more thereof.

The resin composition according to the exemplary embodiment may contain, as the cardanol compound, a mixture of compounds naturally derived from cashews (hereinafter also referred to as “cashew-derived mixture”).

The resin composition according to the exemplary embodiment may contain a derivative from the cashew-derived mixture as the cardanol compound. Examples of the derivative from the cashew-derived mixture include the following mixtures or pure substances.

Mixture prepared by adjusting the composition ratio of each component in the cashew-derived mixture

Pure substance obtained by isolating only a specific component from the cashew-derived mixture

Mixture containing a modified product obtained by modifying components in the cashew-derived mixture

Mixture containing a polymer obtained by polymerizing a component in the cashew-derived mixture

Mixture containing a modified polymer obtained by modifying and polymerizing a component in the cashew-derived mixture

Mixture containing a modified product obtained by further modifying the components in the mixture whose composition ratio is adjusted

Mixture containing a polymer obtained by further polymerizing the component in the mixture whose composition ratio is adjusted

Mixture containing a modified polymer obtained by further modifying and polymerizing the component in the mixture whose composition ratio is adjusted

Modified product obtained by further modifying the isolated pure substance

Polymer obtained by further polymerizing the isolated pure substance

Modified polymer obtained by further modifying and polymerizing the isolated pure substance

Here, the pure substance includes a multimer such as a dimer and a trimer.

The cardanol compound is preferably at least one compound selected from the group consisting of a compound represented by a General Formula (CDN1) and a polymer obtained by polymerizing a compound represented by the General Formula (CDN1), from the viewpoint of obtaining puncture impact strength of the resin molded article.

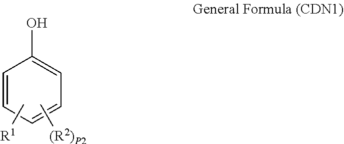

In the General Formula (CDN1), R¹ represents an alkyl group optionally having a substituent, or an unsaturated aliphatic group optionally having a double bond and a substituent. R² represents a hydroxy group, a carboxy group, an alkyl group optionally having a substituent, or an unsaturated aliphatic group optionally having a double bond and a substituent. P2 represents an integer of 0 to 4. When P2 is 2 or more, a plurality of R² may be the same group or different groups.

In the General Formula (CDN1), the alkyl group optionally having a substituent represented by R¹ is preferably an alkyl group having 3 to 30 carbon atoms, more preferably an alkyl group having 5 to 25 carbon atoms, and still more preferably an alkyl group having 8 to 20 carbon atoms.

Examples of the substituent include: a hydroxy group; a substituent containing an ether bond, such as an epoxy group or a methoxy group; a substituent containing an ester bond, such as an acetyl group or a propionyl group; or the like.

Examples of the alkyl group optionally having a substituent include pentadecan-1-yl, heptan-1-yl, octan-1-yl, nonan-1-yl, decan-1-yl, undecan-1-yl, dodecan-1-yl, tetradecan-1-yl, or the like.

In the General Formula (CDN1), the unsaturated aliphatic group optionally having a double bond and a substituent represented by le is preferably an unsaturated aliphatic group having 3 to 30 carbon atoms, more preferably an unsaturated aliphatic group having 5 to 25 carbon atoms, and still more preferably an unsaturated aliphatic group having 8 to 20 carbon atoms.

The number of the double bond contained in the unsaturated aliphatic group is preferably 1 to 3.

Examples of the substituent include those listed as the substituent of the alkyl group.

Examples of the unsaturated aliphatic group optionally having a double bond and a sub stituent include pentadeca-8-en-1-yl, pentadeca-8,11-dien-1-yl, pentadeca-8,11,14-trien-1-yl, pentadec-7-en-1-yl, pentadeca-7,10-dien-1-yl, pentadeca-7,10,14-trien-1-yl, or the like.

In the General Formula (CDN1), le is preferably pentadeca-8-en-1-yl, pentadeca-8,11-dien-1-yl, pentadeca-8,11,14-trien-1-yl, pentadec-7-en-1-yl, pentadeca-7,10-dien-1-yl, and pentadeca-7, 10,14-trien-1-yl.

In the General Formula (CDN1), preferred examples of the alkyl group optionally having a substituent and the unsaturated aliphatic group optionally having a double bond and a substituent, which are represented by R², include those listed as the alkyl group optionally having a substituent and the unsaturated aliphatic group optionally having a double bond and a substituent, which are represented by R¹.

The compound represented by the General Formula (CDN1) may be further modified. For example, the compound may be epoxidized. Specifically, the compound may be a compound having a structure in which the hydroxy group of the compound represented by the

General Formula (CDN1) is replaced with the following group (EP), i.e., a compound represented by the following General Formula (CDN1-e).

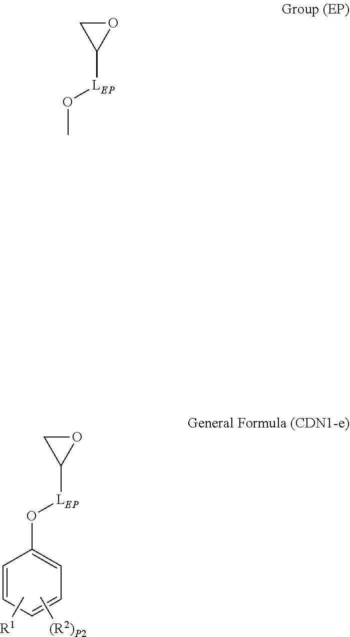

In the group (EP) and the General Formula (CDN1-e), LEP represents a single bond or a divalent linking group. In the General Formula (CDN1-e), R¹, R² and P2 each independently have the same meanings as R¹, R² and P2 in the General Formula (CDN1).

In the group (EP) and the General Formula (CDN1-e), examples of the divalent linking group represented by LEP include an alkylene group optionally having a substituent (preferably an alkylene group having 1 to 4 carbon atoms, and more preferably an alkylene group having 1 carbon atom), —CH₂CH₂OCH₂CH₂—, or the like.

Examples of the substituent include those listed as the substituent for le of the General Formula (CDN1).

L_{EP} is preferably a methylene group.

The polymer obtained by polymerizing a compound represented by the General Formula (CDN1) refers to a polymer obtained by polymerizing at least two compounds represented by the General Formula (CDN1) with or without a linking group.

Examples of the polymer obtained by polymerizing the compound represented by the General Formula (CDN1) include a compound represented by the following General Formula (CDN2).

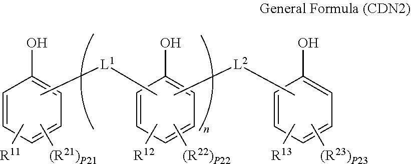

In the General Formula (CDN2), R¹¹, R¹² and R¹³ each independently represent an alkyl group optionally having a substituent, or an unsaturated aliphatic group optionally having a double bond and a substituent. R²¹, R²² and R²³ each independently represent a hydroxy group, a carboxy group, an alkyl group optionally having a substituent, or an unsaturated aliphatic group optionally having a double bond and a substituent. P21 and P23 each independently represent an integer of 0 to 3, and P22 represents an integer of 0 to 2. L¹ and L² each independently represent a divalent linking group. n represents an integer of 0 to 10. A plurality of R²¹ when P21 is 2 or more, a plurality of R²² when P22 is 2 or more, and a plurality of R²³ when P23 is 2 or more may be the same group or different groups, separately. A plurality of R¹², R²², and L¹ when n is 2 or more may be the same group or different groups separately, and a plurality of P22 when n is 2 or more may be the same group or different group.

In the General Formula (CDN2), preferred examples of the alkyl group optionally having a substituent, and the unsaturated aliphatic group optionally having a double bond and a substituent, which are represented by R¹¹, R¹², R¹³, R²¹, R²² and R²³ include those listed for R¹ of the General Formula (CDN1).

In the General Formula (CDN2), examples of the divalent linking group represented by L¹ and L² include an alkylene group optionally having a substituent (preferably an alkylene group having 2 to 30 carbon atoms, and more preferably an alkylene group having 5 to 20 carbon atoms), or the like.

Examples of the substituent include those listed as the substituent for le of the General Formula (CDN1).

In the General Formula (CDN2), n is preferably 1 to 10, and more preferably 1 to 5.

The compound represented by the General Formula (CDN2) may be further modified. For example, the compound may be epoxidized. Specifically, the compound may be a compound having a structure in which the hydroxy group of the compound represented by the General Formula (CDN2) is replaced with the group (EP), i.e., a compound represented by the following General Formula (CDN2-e).

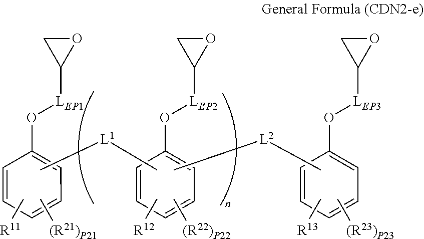

In the General Formula (CDN2-e), R¹¹, R¹², R¹³, R²¹, R²², R²³, P21, P22, P23, L¹, and L² each have the same meaning as R¹¹, R¹², R¹³, R²¹, R²², R²³, P21, P22, P23, L¹, L² and n in the general formula (CDN2).

In the General Formula (CDN2-e), LEP1, LEP2 and LEP3 each independently represent a single bond or a divalent linking group. When n is 2 or more, a plurality of LEP2 may be the same group or different groups.

In the General Formula (CDN2-e), preferred examples of the divalent linking group represented by LEP1, LEP2 and LEP3 include those listed for the divalent linking group represented by LEP in the General Formula (CDN1-e).

The polymer obtained by polymerizing a compound represented by the General Formula (CDN1) may be, for example, a polymer obtained by three-dimensionally crosslinking and polymerizing at least three compounds represented by the General Formula (CDN1) with or without a linking group. Examples of the polymer obtained by three-dimensionally crosslinking and polymerizing the compound represented by the General Formula (CDN1) include a compound represented by the following structural formula.

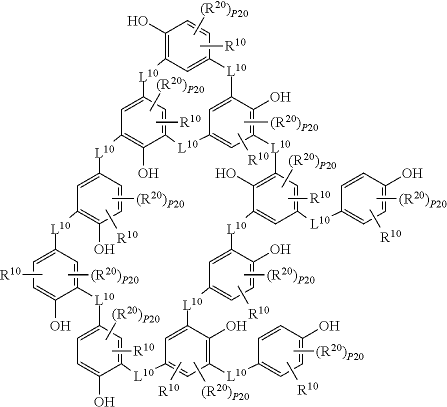

In the above structural formula, R¹⁰, R²⁰ and P20 each independently have the same meanings as R¹, R² and P2 in the General Formula (CDN1). L¹⁰ represents a single bond or a divalent linking group. A plurality of R¹⁰ , R²⁰ and L¹⁰ may be the same group or different groups, separately. A plurality of P²⁰ may be the same number or different numbers.

In the above structural formula, examples of the divalent linking group represented by L¹⁰ include an alkylene group optionally having a substituent (preferably an alkylene group having 2 to 30 carbon atoms, and more preferably an alkylene group having 5 to 20 carbon atoms), or the like.

Examples of the substituent include those listed as the substituent for R¹ of the General Formula (CDN1).

The compound represented by the above structural formula may be further modified. For example, the compound may be epoxidized. Specifically, the compound may be a compound having a structure in which the hydroxy group of the compound represented by the above structural formula is replaced by the group (EP), for example, a polymer represented by the following structural formula, i.e., a polymer obtained by three-dimensionally crosslinking and polymerizing the compound represented by the General Formula (CDN1-e).

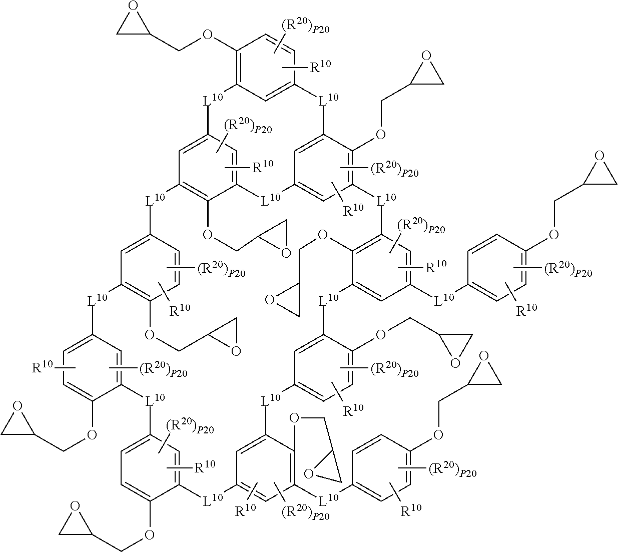

In the above structural formula, R¹⁰, R²⁰ and P20 each independently have the same meanings as R¹, R² and P2 in the General Formula (CDN1-e). L¹⁰ represents a single bond or a divalent linking group. A plurality of R¹⁰, R²⁰ and L¹⁰ may be the same group or different groups, separately. A plurality of P²⁰ may be the same number or different numbers.

In the above structural formula, examples of the divalent linking group represented by L¹⁰ include an alkylene group optionally having a substituent (preferably an alkylene group having 2 to 30 carbon atoms, and more preferably an alkylene group having 5 to 20 carbon atoms), or the like.

Examples of the substituent include those listed as the substituent for R¹ of the General Formula (CDN1).

The cardanol compound preferably contains a cardanol compound having an epoxy group, and is more preferably a cardanol compound having an epoxy group, from the viewpoint of improving puncture impact strength of the resin molded article.

A commercially available product may be used as the cardanol compound. Examples of the commercially available product include: NX-2024, Ultra LITE 2023, NX-2026, GX-2503, NC-510, LITE 2020, NX-9001, NX-9004, NX-9007, NX-9008, NX-9201, and NX-9203, manufactured by Cardolite Corporation; LB-7000, LB-7250, and CD-5L manufactured by Tohoku Chemical Industry Co., Ltd.; or the like.

Examples of the commercially available product of the cardanol compound having an epoxy group include NC-513, NC-514S, NC-547, LITE 513E, and Ultra LTE 513 manufactured by Cardolite Corporation.

The cardanol compound preferably has a hydroxyl value of 100 mgKOH/g or more, more preferably 120 mgKOH/g or more, and still more preferably 150 mgKOH/g or more, from the viewpoint of obtaining puncture impact strength of the resin molded article. The hydroxyl value of the cardanol compound is measured according to Method A of ISO14900.

When a cardanol compound having an epoxy group is used as the cardanol compound, an epoxy equivalent is preferably 300 to 500, more preferably 350 to 480, and still more preferably 400 to 470, from the viewpoint of improving puncture impact strength of the resin molded article. The epoxy equivalent of the cardanol compound having an epoxy group is measured according to ISO3001.

### —Ester Compound—

### —Ester Compound—

The ester compound contained as the plasticizer (C) in the resin composition according to the exemplary embodiment is not particularly limited as long as it is an ester compound other than the compounds represented by the General Formulas (1) to (5). Examples of the ester compound as the plasticizer (C) include a dicarboxylic diester, a citric acid ester, a polyether ester compound, a glycol benzoate, a compound represented by the following General Formula (6), an epoxidized fatty acid ester, or the like. Examples of the ester include a monoester, a diester, a triester, and a polyester.

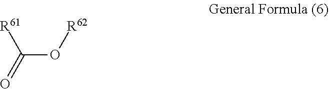

In the General Formula (6), R⁶¹ represents an aliphatic hydrocarbon group having 7 to 28 carbon atoms, and R⁶² represents an aliphatic hydrocarbon group having 1 to 8 carbon atoms. The specific form and preferred form of the group represented by R⁶¹ include the same form as the group represented by R¹¹ in the General Formula (1).

The group represented by R⁶² may be a saturated aliphatic hydrocarbon group, or an unsaturated aliphatic hydrocarbon group, and is preferably a saturated aliphatic hydrocarbon group. The group represented by R⁶² may be a linear aliphatic hydrocarbon group, a branched aliphatic hydrocarbon group, or an aliphatic hydrocarbon group containing an alicyclic ring, and is preferably a linear aliphatic hydrocarbon group. The group represented by R⁶² may be a group in which a hydrogen atom in the aliphatic hydrocarbon group is substituted with a halogen atom (e.g., a fluorine atom, a bromine atom and an iodine atom), an oxygen atom, a nitrogen atom or the like, and is preferably unsubstituted. The group represented by R⁶² preferably has 2 or more carbon atoms, more preferably 3 or more carbon atoms, and still more preferably 4 or more carbon atoms.

Specific examples of the ester compound contained as the plasticizer (C) include adipates, citrates, sebacates, azelates, phthalates, acetates, dibasiates, phosphates, condensed phosphates, glycol esters (e.g., glycol benzoate), modified products of fatty acid esters (e.g., epoxidized fatty acid esters), or the like. Examples of the above ester include a monoester, a diester, a triester, and a polyester. Of these, dicarboxylic diesters (e.g., adipic acid diester, sebacic acid diester, azelaic acid diester, and phthalic acid diester) are preferred.

The plasticizer (C) is preferably an adipate ester. The adipate ester has high affinity with a resin, particularly the cellulose acylate (A), and disperses in a state close to uniformity to a resin, particularly the cellulose acylate (A), thereby further improving the thermal fluidity as compared with another plasticizer.

The ester compound contained as the plasticizer (C) in the resin composition according to the exemplary embodiment preferably has a molecular weight (or a weight average molecular weight) of 200 to 2000, more preferably 250 to 1500, and still more preferably 280 to 1000. The weight average molecular weight of the ester compound is not particularly limited, and is a value measured according to the method of measuring the weight average molecular weight of the cellulose acylate (A).

Examples of the adipate ester include an adipate diester and an adipate polyester. Specifically, examples include an adipate diester represented by the following General Formula (AE) and an adipate polyester represented by the following General Formula (APE).

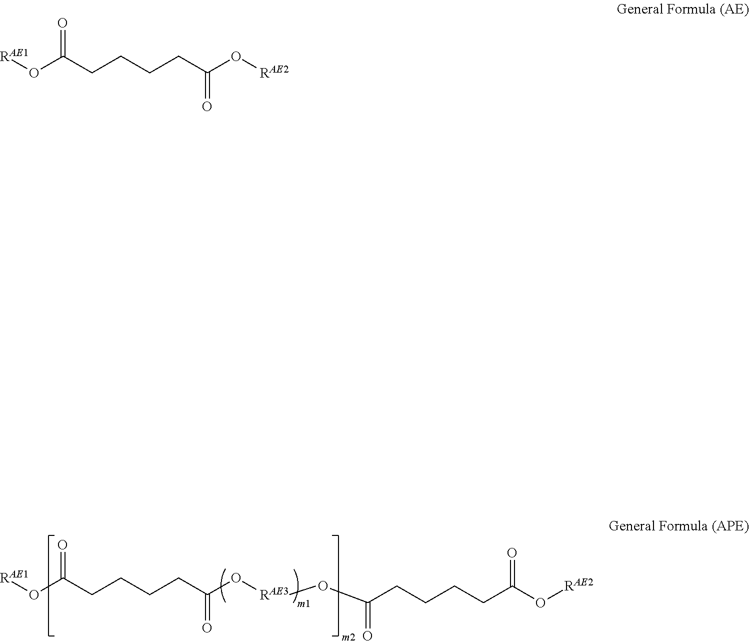

In the General Formula (AE), R^{AE1} and R^{AE2} each independently represent an alkyl group or a polyoxyalkyl group [—(CₓH₂ₓ—O)_{y}—R^{A1}] (Here, R^{A1} represents an alkyl group, x represents an integer of 1 to 10, and y represents an integer of 1 to 10.).

In the General Formula (APE), R^{AE1} and R^{AE2} each independently represent an alkyl group or a polyoxyalkyl group [—(CₓH₂ₓ—O)_{y}—R^{A1}] (Here, R^{A1} represents an alkyl group, x represents an integer of 1 to 10, and y represents an integer of 1 to 10.), and R^{AE3} represents an alkylene group. ml represents an integer of 1 to 10, and m2 represents an integer of 1 to 20.

In the General Formula (AE) and the General Formula (APE), the alkyl group represented by R^{AE1} and R^{AE2} is preferably an alkyl group having 1 to 12 carbon atoms, more preferably an alkyl group having 4 to 10 carbon atoms, and still more preferably an alkyl group having 8 carbon atoms. The alkyl group represented by R^{AE1} and R^{AE2} may be linear, branched or cyclic, and is preferably linear or branched.

In the polyoxyalkyl group [—(CₓH_{2X}—O)_{y}—R^{A1}] represented by R^{AE1} and R^{AE2} in the General Formula (AE) and the General Formula (APE), the alkyl group represented by R^{A1} is preferably an alkyl group having 1 to 6 carbon atoms, and more preferably an alkyl group having 1 to 4 carbon atoms. The alkyl group represented by R^{A1} may be linear, branched or cyclic, and is preferably linear or branched.

In the general formula (APE), the alkylene group represented by R^{AE3} is preferably an alkylene group having 1 to 6 carbon atoms, and more preferably an alkylene group having 1 to 4 carbon atoms. The alkylene group may be linear, branched or cyclic, and is preferably linear or branched.

In the General Formula (APE), ml is preferably an integer of 1 to 5, and m2 is preferably an integer of 1 to 10.

In the General Formula (AE) and the General Formula (APE), the group represented by each symbol may be substituted with a substituent. Examples of the substituent include an alkyl group, an aryl group, a hydroxy group, or the like.

The adipate ester preferably has a molecular weight (weight average molecular weight) of 250 to 2000, more preferably 280 to 1500, and still more preferably 300 to 1000. The weight average molecular weight of the adipate ester is a value measured according to the method of measuring the weight average molecular weight of the cellulose acylate (A).

A mixture of an adipate ester and other components may be used as the adipate ester. Examples of the commercially available product of the mixture include Daifatty 101 manufactured by DAIHACHI CHEMICAL INDUSTRY CO., LTD.

The hydrocarbon group at the end of a fatty acid ester such as citric acid ester, sebacic acid ester, azelaic acid ester, phthalic acid ester, and acetic acid ester is preferably an aliphatic hydrocarbon group, preferably an alkyl group having 1 to 12 carbon atoms, more preferably an alkyl group having 4 to 10 carbons, and still more preferably an alkyl group having 8 carbons. The alkyl group may be linear, branched or cyclic, and is preferably linear or branched.

Examples of the fatty acid esters such as citric acid ester, sebacic acid ester, azelaic acid ester, phthalic acid ester, and acetic acid ester include an ester of a fatty acid and an alcohol. Examples of the alcohol include: monohydric alcohols such as methanol, ethanol, propanol, butanol, and 2-ethylhexanol; polyhydric alcohols such as glycerin, a polyglycerol (diglycerin or the like), pentaerythritol, ethylene glycol, diethylene glycol, propylene glycol, butylene glycol, trimethylolpropane, trimethylol ethane, and a sugar alcohol; or the like.

Examples of the glycol in the glycol benzoate include ethylene glycol, diethylene glycol, propylene glycol, or the like.

The epoxidized fatty acid ester is an ester compound having a structure (that is, oxacyclopropane) in which an unsaturated carbon-carbon bond of an unsaturated fatty acid ester is epoxidized. Examples of the epoxidized fatty acid ester include an ester of a fatty acid and an alcohol in which part or the entire unsaturated carbon-carbon bond in an unsaturated fatty acid (e.g., oleic acid, palmitoleic acid, vaccenic acid, linoleic acid, linolenic acid, and nervonic acid) is epoxidized. Examples of the alcohol include: monohydric alcohols such as methanol, ethanol, propanol, butanol, and 2-ethylhexanol; polyhydric alcohols such as glycerin, a polyglycerol (diglycerin or the like), pentaerythritol, ethylene glycol, diethylene glycol, propylene glycol, butylene glycol, trimethylolpropane, trimethylol ethane, and a sugar alcohol; or the like.

Examples of the commercially available product of the epoxidized fatty acid ester include ADK Cizer D-32, D-55, 0-130P, and 0-180A (manufactured by ADEKA), and Sanso Cizer E-PS, nE-PS, E-PO, E-4030, E-6000, E-2000H, and E-9000H (manufactured by New Japan Chemical Co., Ltd.).

The polyether ester compound may be either a polyester unit or a polyether unit, each of which is aromatic or aliphatic (including alicyclic). The mass ratio of the polyester unit to the polyether unit is, for example, 20:80 to 80:20. The polyether ester compound preferably has a molecular weight (weight average molecular weight) of 250 to 2000, more preferably 280 to 1500, and still more preferably 300 to 1000. Examples of the commercially available product of the polyether ester compound include ADK Cizer RS-1000 (manufactured by ADEKA).

Examples of the polyether compound having at least one unsaturated bonds in the molecule include a polyether compound having an allyl group at the end, and a polyalkylene glycol allyl ether is preferred. The polyether compound having at least one unsaturated bonds in the molecule has a molecular weight (weight average molecular weight) of 250 to 2000, more preferably 280 to 1500, and still more preferably 300 to 1000. Examples of the commercially available product of the polyether compound having at least one unsaturated bonds in the molecule include polyalkylene glycol allyl ethers such as UNIOX PKA-5006, UNIOX PKA-5008, UNIOL PKA-5014, and UNIOL PKA-5017 (manufactured by NOF CORPORATION).

### [Thermoplastic Elastomer (D): Component (D)]

The resin composition according to the exemplary embodiment preferably further contains a thermoplastic elastomer (D) from the viewpoint of obtaining puncture impact strength in the obtained resin molded article.

The thermoplastic elastomer (D) is at least one thermoplastic elastomer selected from the group consisting of a core-shell structure polymer (d1), which includes a core layer containing a butadiene polymer, and a shell layer containing a polymer selected from a styrene polymer and an acrylonitrile-styrene polymer on the surface of the core layer;

a core-shell structure polymer (d2), which includes a core layer and a shell layer containing an alkyl (meth)acrylate polymer on the surface of the core layer;

an olefin polymer (d3), which is a polymer of an α-olefin and an alkyl (meth)acrylate and contains 60 mass % or more of a structural unit derived from the α-olefin;

a styrene-ethylene-butadiene-styrene copolymer (d4);

a polyurethane (d5); and

a polyester (d6).

The component (D) is, for example, a thermoplastic elastomer having elasticity at ordinary temperature (25° C.) and softening at a high temperature like a thermoplastic resin.

From the viewpoint of obtaining puncture impact strength in the obtained resin molded article, the thermoplastic elastomer (D) preferably contains at least one thermoplastic elastomer selected from the group consisting of: a core-shell structure polymer (d1), which contains a core layer containing a butadiene polymer, a core layer containing a butadiene polymer, and a shell layer containing a polymer selected from a styrene polymer and an acrylonitrile/styrene polymer on the surface of the core layer; a core-shell structure polymer (d2), which contains a core layer and a shell layer containing an alkyl (meth)acrylate polymer on the surface of the core layer; a styrene-ethylene-butadiene-styrene copolymer (d4); a polyurethane (d5); and a polyester (d6), more preferably contains at least one thermoplastic elastomer selected from the group consisting of: a core-shell structure polymer (d1), which contains a core layer containing a butadiene polymer, a core layer containing a butadiene polymer, and a shell layer containing a polymer selected from a styrene polymer and an acrylonitrile/styrene polymer on the surface of the core layer; and a core-shell structure polymer (d2), which contains a core layer and a shell layer containing an alkyl (meth)acrylate polymer on the surface of the core layer, and still more preferably contains a core-shell structure polymer (d2), which contains a core layer and a shell layer containing an alkyl (meth)acrylate polymer on the surface of the core layer.

From the viewpoint of obtaining puncture impact strength in the obtained resin molded article, the thermoplastic elastomer (D) is preferably a particulate thermoplastic elastomer. That is, the resin composition according to the exemplary embodiment preferably contains thermoplastic elastomer particles as the thermoplastic elastomer (D), from the viewpoint of obtaining puncture impact strength in the obtained resin molded article.

(Core-Shell Structure Polymer (d1): Component (d1))

The core-shell structure polymer (d1) is a polymer having a core-shell structure with a core layer and a shell layer on the surface of the core layer.

The core-shell structure polymer (d1) is a polymer having a core layer as the innermost layer and a shell layer as the outermost layer (specifically, a shell layer polymer obtained by grafting and polymerizing an alkyl (meth)acrylate polymer to a core layer polymer).

One or more other layers (for example, one to six other layers) may be provided between the core layer and the shell layer. When another layer is provided between the core layer and the shell layer, the core-shell structure polymer (d1) is a multi-layer polymer obtained by grafting and polymerizing a plurality of polymers to a core layer polymer.

The core layer is not particularly limited, and is preferably a rubber layer. Examples of the rubber layer include a layer of a (meth)acrylic rubber, a silicone rubber, a styrene rubber, a conjugated diene rubber, an α-olefin rubber, a nitrile rubber, a urethane rubber, a polyester rubber, a polyamide rubber, and a copolymer rubber of two or more of the above rubbers. Of these, the rubber layer is preferably a layer of a (meth)acrylic rubber, a silicone rubber, a styrene rubber, a conjugated diene rubber, an α-olefin rubber, and a copolymer rubber of two or more of the above rubbers. The rubber layer may be obtained by copolymerizing and crosslinking agents (divinylbenzene, allyl acrylate, butylene glycol diacrylate or the like).

Examples of the (meth)acrylic rubber include a polymer rubber obtained by polymerizing a (meth)acrylic component (for example, alkyl esters of (meth)acrylic acid having 2 to 8 carbon atoms).

Examples of the silicone rubber include a rubber containing a silicone component (polydimethylsiloxane, polyphenylsiloxane, or the like).

Examples of the styrene rubber include a polymer rubber obtained by polymerizing a styrene component (styrene, a-methylstyrene, or the like).

Examples of the conjugated diene rubber include a polymer rubber obtained by polymerizing a conjugated diene component (butadiene, isoprene, or the like).

Examples of the α-olefin rubber include a polymer rubber obtained by polymerizing an α-olefin component (ethylene, propylene, and 2-methylpropylene).

Examples of the copolymer rubber include a copolymer rubber obtained by polymerizing two or more kinds of (meth)acrylic components, a copolymer rubber obtained by polymerizing two or more kinds of (meth)acrylic components, a copolymer of a (meth)acrylic component, a conjugated diene component and a styrene component, or the like.

Examples of the alkyl (meth)acrylate in the polymer constituting the shell layer include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, octadecyl (meth)acrylate, or the like. In the alkyl (meth)acrylate, at least a part of the hydrogen of the alkyl chain may be substituted. Examples of the substituent include an amino group, a hydroxyl group, a halogeno group, or the like.

Of these, the alkyl (meth)acrylate polymer is preferably an alkyl (meth)acrylate polymer having an alkyl chain with 1 to 8 carbon atoms, more preferably an alkyl (meth)acrylate polymer having an alkyl chain with 1 to 2 carbon atoms, and still more preferably an alkyl (meth)acrylate polymer having an alkyl chain with 1 carbon atom, from the viewpoint of easily obtaining the effect of improving the toughness by adding the component (B).

The polymer constituting the shell layer may be, in addition to the alkyl (meth)acryl ate, a polymer obtained by polymerizing at least one selected from a glycidyl group-containing vinyl compound and an unsaturated dicarboxylic anhydride.

Examples of the glycidyl group-containing vinyl compound include glycidyl (meth)acrylate, glycidyl itaconate, diglycidyl itaconate, allyl glycidyl ether, styrene-4-glycidyl ether, 4-glycidyl styrene, or the like.

Examples of the unsaturated dicarboxylic anhydride include maleic anhydride, itaconic anhydride, glutaconic anhydride, citraconic anhydride, aconitic anhydride, or the like. Of these, maleic anhydride is preferred.

When another layer is provided between the core layer and the shell layer, a layer of a polymer described for the shell layer is exemplified as another layer.

The mass percentage of the shell layer to the entire core-shell structure is preferably 1 mass % to 40 mass %, more preferably 3 mass % to 30 mass %, and still more preferably 5 mass % to 15 mass %.

The average primary particle diameter of the core-shell structure polymer is not particularly limited, and is preferably 50 nm to 500 nm, more preferably 50 nm to 400 nm, still more preferably 100 nm to 300 nm, and particularly preferably 150 nm to 250 nm, from the viewpoint of easily obtaining the effect of improving the toughness by adding the component (B).

The average primary particle diameter refers to a value measured by the following method. Particles are observed with a scanning electron microscope, the maximum diameter of the primary particles is taken as the primary particle diameter, and the primary particle diameter of 100 particles is measured and averaged to obtain the average primary particle diameter. Specifically, the average primary particle diameter is obtained by observing the dispersed form of the core-shell structure polymer in the resin composition with a scanning electron microscope.

The core-shell structure polymer (d1) may be prepared by a known method. Examples of the known method include an emulsion polymerization method. Specifically, the following method is exemplified as a manufacturing method. First, a mixture of monomers is subjected to emulsion polymerization to prepare core particles (core layer), and thereafter a mixture of other monomers is subjected to emulsion polymerization in the presence of the core particles (core layer) to prepare a core-shell structure polymer forming a shell layer around the core particles (core layer). When another layer is formed between the core layer and the shell layer, the emulsion polymerization of the mixture of other monomers is repeated to obtain a desired core-shell structure polymer including a core layer, another layer and a shell layer.

Examples of the commercially available product of the core-shell structure polymer (d1) include “METABLEN” (Registered trademark) manufactured by Mitsubishi Chemical Corporation, “Kane Ace” (Registered trademark) manufactured by Kaneka Corporation, “PARALOID” (Registered trademark) manufactured by the Dow Chemical Japan, “STAPHYLOID” (Registered trademark) manufactured by Aica Kogyo Company, Limited, “Paraface” (Registered trademark) manufactured by KURARAY CO., LTD., or the like.

(Core-Shell Structure Polymer (d2): Component (d2))

The core-shell structure polymer (d2) is a polymer having a core-shell structure with a core layer and a shell layer on the surface of the core layer.

The core-shell structure polymer (d2) is a polymer having a core layer as the innermost layer and a shell layer as the outermost layer (specifically, a shell layer polymer obtained by grafting and polymerizing a styrene polymer or an acrylonitrile-styrene polymer to a core layer containing a butadiene polymer).

One or more other layers (for example, one to six other layers) may be provided between the core layer and the shell layer. When another layer is provided between the core layer and the shell layer, the core-shell structure polymer (d2) is a multi-layer polymer obtained by grafting and polymerizing a plurality of polymers to a core layer polymer.

The core layer containing a butadiene polymer is not particularly limited as long as it contains a polymer obtained by polymerizing a component containing butadiene, and may be a core layer containing a homopolymer of butadiene, or a core layer containing a copolymer of butadiene and another monomer. When the core layer contains a copolymer of butadiene and another monomer, examples of another monomer include vinyl aromatic monomers. Of the vinyl aromatic monomers, styrene components (for example, styrene, an alkyl-substituted styrene (e.g., a-methylstyrene, 2-methylstyrene, 3-methylstyrene, 4-methylstyrene, 2-ethylstyrene, 3-ethylstyrene, and 4-ethylstyrene), and a halogen-substituted styrene (e.g., 2-chlorostyrene, 3-chlorostyrene, and 4-chlorostyrene)) are preferred. The styrene component may be used alone, or may be used in combination of two or more thereof. Of these styrene components, styrene is preferably used. Polyfunctional monomers such as an allyl (meth)acrylate, a triallyl isocyanurate, and divinylbenzene may be used as another monomer.

Specifically, the core layer containing a butadiene polymer may be, for example, a homopolymer of butadiene, a copolymer of butadiene and styrene, or a terpolymer of butadiene, styrene and divinylbenzene.

The butadiene polymer contained in the core layer contains 60 mass % to 100 mass % (preferably, 70 mass % to 100 mass %) of a structural unit derived from butadiene and 0 mass % to 40 mass % (preferably, 0 mass % to 30 mass %) of a structural unit derived from another monomer (preferably, a styrene component). For example, the percentage of the structural unit derived from each monomer constituting the butadiene polymer is 60 mass % to 100 mass % for butadiene and 0 mass % to 40 mass % for styrene. The percentage is preferably 0 mass % to 5 mass % for divinylbenzene based on the total amount of styrene and divinylbenzene.

The shell layer containing a styrene polymer is not particularly limited as long as it is a shell layer containing a polymer obtained by polymerizing a styrene component, and may be a shell layer containing a homopolymer of styrene, or a shell layer containing a copolymer of styrene and another monomer. Examples of the styrene component include the styrene component as exemplified for the core layer. Examples of other monomer include alkyl (meth)acrylates (for example, methyl (meth)acryl ate, ethyl (meth)acrylate, n-propyl (meth)acrylate, n-butyl (meth)acrylate, t-butyl (meth)acryl ate, n-hexyl (meth)acryl ate, 2-ethylhexyl (meth)acrylate, cyclohexyl (meth)acrylate, and octadecyl (meth)acrylate), or the like. In the alkyl (meth)acrylate, at least a part of the hydrogen of the alkyl chain may be substituted. Examples of the sub stituent include an amino group, a hydroxyl group, a halogeno group, or the like. The alkyl (meth)acrylate may be used alone, or may be used in combination of two or more thereof. Polyfunctional monomers such as an allyl (meth)acrylate, a triallyl isocyanurate, and divinylbenzene may be used as another monomer. The styrene polymer contained in the shell layer is preferably a copolymer of a styrene component in an amount of 85 mass % to 100 mass % and another monomer component (preferably, an alkyl (meth)acrylate) in an amount of 0 mass % to 15 mass %.

Of these, the styrene polymer contained in the shell layer is preferably a copolymer of styrene and an alkyl (meth)acrylate from the viewpoint of easily obtaining the effect of improving the toughness by adding the component (B). From the same viewpoint, a copolymer of styrene and an alkyl (meth)acrylate having an alkyl chain with 1 to 8 carbon atoms is preferred, and an alkyl (meth)acrylate polymer having an alkyl chain with 1 to 4 carbon atoms is more preferred.

The shell layer containing an acrylonitrile-styrene polymer is a shell layer containing a copolymer of an acrylonitrile component and a styrene component. The acrylonitrile-styrene polymer is not particularly limited and examples thereof include a known acrylonitrile-styrene polymer. Examples of the acrylonitrile-styrene polymer include a copolymer of an acrylonitrile component in an amount of 10 mass % to 80 mass % and a styrene component in an amount of 20 mass % to 90 mass %. Examples of the styrene component copolymerizing with the acrylonitrile component include the styrene component as exemplified for the core layer. Polyfunctional monomers such as an allyl (meth)acrylate, a triallyl isocyanurate, divinylbenzene or the like may be used as the acrylonitrile-styrene polymer contained in the shell layer.

When another layer is provided between the core layer and the shell layer, a layer of a polymer described for the shell layer is exemplified as another layer.

The mass percentage of the shell layer to the entire core-shell structure is preferably 1 mass % to 40 mass %, more preferably 3 mass % to 30 mass %, and still more preferably 5 mass % to 15 mass %.

Of the component (d2), examples of the commercially available product of the core-shell structure polymer (d2) including a core layer containing a butadiene polymer and a shell layer containing a styrene polymer on the surface of core layer include “METABLEN” (registered trademark) manufactured by Mitsubishi Chemical Corporation, “Kane Ace” (Registered trademark) manufactured by Kaneka Corporation, “Clearstrength” (registered trademark) manufactured by Arkema S.A., and “PARALOID” (Registered trademark) manufactured by the Dow Chemical Japan.

Of the component (d2), examples of the commercially available product of the core-shell structure polymer (d2) including a core layer containing a butadiene polymer and a shell layer containing an acrylonitrile-styrene polymer on the surface of core layer include “Blendex” (registered trademark) manufactured by Galata Chemicals, “ELIX” manufactured by ELIX POLYMERS, or the like.

(Olefin Polymer (d3): Component (d3))

The olefin polymer (d3) is a polymer of an α-olefin and an alkyl (meth)acrylate and preferably contains 60 mass % or more of a structural unit derived from the α-olefin.

Examples of the α-olefin in the olefin polymer include ethylene, propylene, 2-methylpropylene, or the like. An α-olefin having 2 to 8 carbon atoms is preferred, and an α-olefin having 2 to 3 carbon atoms is more preferred, from the viewpoint of easily obtaining the effect of improving the toughness by adding the component (B). Of these, ethylene is still more preferred.

Examples of the alkyl (meth)acrylate polymerizing with the α-olefin include methyl (meth)acrylate, ethyl (meth)acrylate, n-propyl (meth)acrylate, n-butyl (meth)acrylate, t-butyl (meth)acrylate, n-hexyl (meth)acrylate, 2-ethylhexyl (meth)acrylate, cyclohexyl (meth)acrylate, octadecyl (meth)acrylate, or the like. An alkyl (meth)acrylate having an alkyl chain with 1 to 8 carbon atoms is preferred, an alkyl (meth)acrylate having an alkyl chain with 1 to 4 carbon atoms is more preferred, and an alkyl (meth)acrylate having an alkyl chain with 1 to 2 carbon atoms is still more preferred, from the viewpoint of easily obtaining the effect of improving the toughness by adding the component (B).

The olefin polymer is preferably a polymer of ethylene and methyl acrylate from the viewpoint of easily obtaining the effect of improving the toughness by adding the component (B).

The olefin polymer preferably contains 60 mass % to 97 mass % of and more preferably 70 mass % to 85 mass % of a structural unit derived from the α-olefin, from the viewpoint of easily obtaining the effect of improving the toughness by adding the component (B).

The olefin polymer may contain the structural unit derived from the α-olefin and another structural unit derived from an alkyl (meth)acrylate. However, another structural unit is preferably 10 mass % or less based on all the structural units in the olefin polymer.

(Styrene-ethylene-butadiene-styrene Copolymer (d4): Component (d4))

The copolymer (d4) is not particularly limited as long as it is a thermoplastic elastomer, and examples thereof include a styrene-ethylene-butadiene-styrene copolymer. The copolymer (d4) may be a styrene-ethylene-butadiene-styrene copolymer and a hydrogenated product thereof.

The copolymer (d4) is preferably a hydrogenated product of a styrene-ethylene-butadiene-styrene copolymer from the viewpoint of easily obtaining the effect of improving the toughness by adding the component (B). From the same viewpoint, the copolymer (d4) is preferably a block copolymer, and, for example, is preferably a copolymer (styrene-ethylene/butylene-styrene triblock copolymer) having a block of the styrene portion at both ends and a block of a central portion containing ethylene/butylene by hydrogenating at least a part of the double bond of the butadiene portion. The ethylene/butylene block portion of the styrene-ethylene/butylene-styrene copolymer may be a random copolymer.

The copolymer (d4) is obtained by a known method. When the copolymer (d4) is a hydrogenated product of the styrene-ethylene-butadiene-styrene copolymer, for example, the copolymer may be obtained by hydrogenating the butadiene portion of a styrene-butadiene-styrene block copolymer in which the conjugated diene portion includes a 1,4 bond.

Examples of the commercially available product of the copolymer (d4) include “Kraton” (registered trademark) manufactured by Kraton Corporation, “Septon” (registered trademark) manufactured by Kuraray CO., LTD., or the like.

(Polyurethane (d5): Component (d5))

The polyurethane (d5) is not particularly limited as long as it is a thermoplastic elastomer, and examples thereof include a known polyurethane. The polyurethane (d5) is preferably a linear polyurethane. The polyurethane (d5) is obtained, for example, by reacting a polyol component (a polyether polyol, a polyester polyol, a polycarbonate polyol, or the like), an organic isocyanate component (an aromatic diisocyanate, an aliphatic (including alicyclic) diisocyanate, or the like), and, if necessary, a chain extender (an aliphatic (including alicyclic) diol, or the like). Each of the polyol component and the organic isocyanate component may be used alone, or may be used in combination of two or more thereof.

The polyurethane (d5) is preferably an aliphatic polyurethane from the viewpoint of easily obtaining the effect of improving the toughness by adding the component (B). The aliphatic polyurethane is preferably obtained, for example, by reacting a polyol component containing a polycarbonate polyol with an isocyanate component containing an aliphatic diisocyanate.

The polyurethane (d5) may be obtained by reacting a polyol component with an organic isocyanate component in a manner that a value of the NCO/OH ratio in the raw material in the synthesis of polyurethane is within a range of 0.90 to 1.5. The polyurethane (d5) is obtained by a known method such as a one-shot method, a prepolymerization method or the like.

Examples of the commercially available product of the polyurethane (d5) include “Estane” (registered trademark) manufactured by Lubrizol Corporation, “Elastollan” (registered trademark) manufactured by BASF, or the like. Examples also include “Desmopan” (registered trademark) manufactured by Bayer, or the like.

(Polyester (d6): Component (d6))

The polyester (d6) is not particularly limited as long as it is a thermoplastic elastomer, and examples thereof include a known polyester. The polyurethane (d6) is preferably an aromatic polyester from the viewpoint of easily obtaining the effect of improving the toughness by adding the component (B). In the exemplary embodiment, the aromatic polyester represents a polyester having an aromatic ring in the structure thereof.

Examples of the polyester (d6) include a polyester copolymer (polyether ester, polyester ester, or the like). Specific examples include a polyester copolymer having a hard segment including a polyester unit and a soft segment including a polyester unit; a polyester copolymer having a hard segment including a polyester unit and a soft segment including a polyether unit; and a polyester copolymer having a hard segment including a polyester unit and a soft segment including a polyether unit and a polyester unit. The mass ratio (hard segment/soft segment) of the hard segment to the soft segment in the polyester copolymer is preferably, for example, 20/80 to 80/20. The polyester unit constituting the hard segment and the polyester unit and the polyether unit constituting the soft segment may be either aromatic or aliphatic (including alicyclic).

The polyester copolymer as the polyester (d6) may be obtained by a known method. The polyester copolymer is preferably a linear polyester copolymer. The polyester copolymer is obtained, for example, by esterifying or transesterifying a dicarboxylic acid component having 4 to 20 carbon atoms, a diol component having 2 to 20 carbon atoms and a polyalkylene glycol component having a number average molecular weight of 300 to 20000 (containing an alkylene oxide adduct of polyalkylene glycols) (an esterification or transesterification method) to produce an oligomer, and thereafter polycondensating the oligomer (a polycondensation method). In addition, examples of the esterification or transesterification method include a method using a dicarboxylic acid component having 4 to 20 carbon atoms, a diol component having 2 to 20 carbon atoms, and an aliphatic polyester component having a number average molecular weight of 300 to 20000. The dicarboxylic acid component is an aromatic or aliphatic dicarboxylic acid or an ester derivative thereof, the diol component is an aromatic or aliphatic diol, and the polyalkylene glycol component is an aromatic or aliphatic polyalkylene glycol.

Of these, it is preferable to use a dicarboxylic acid component having an aromatic ring as the dicarboxylic acid component of the polyester copolymer from the viewpoint of easily obtaining the effect of improving the toughness by adding the component (B). It is preferable to use an aliphatic diol component and an aliphatic polyalkylene glycol component as the diol component and the polyalkylene glycol component, respectively.

Examples of the commercially available product of the polyester (d6) include “PELPRENE” (registered trademark) manufactured by Toyobo Co., Ltd. and “Hytrel” (registered trademark) manufactured by DU PONT-TORAY CO., LTD.

The thermoplastic elastomer (D) may be used alone, or may be used in combination of two or more thereof.

### [Content or Content Ratio of Each Component]

The resin composition according to the exemplary embodiment contains a resin having biomass-derived carbon atoms (such as the component (A)), and optionally contains the component (B), the component (C), and the component (D), and may contain other components (E) described later. In the resin composition according to the exemplary embodiment, the content or the content ratio (all based on mass) of each component is preferably in the following range from the viewpoint of obtaining puncture impact strength of the obtained resin molded article.

The abbreviation of each component is as follows.

Component (A)=cellulose acylate (A)

Component (B)=ester compound (B)

Component (C)=plasticizer (C)

Component (D)=thermoplastic elastomer (D)

The content of the resin having biomass-derived carbon atoms in the resin composition according to the exemplary embodiment is preferably 50 mass % or more, more preferably 60 mass % or more, and still more preferably 70 mass % or more, based on the total mass of the resin composition.

The content of the component (A) in the resin composition according to the exemplary embodiment is preferably 50 mass % or more, more preferably 60 mass % or more, and still more preferably 70 mass % or more, based on the total mass of the resin composition. The content of the component (A) in the resin composition according to the exemplary embodiment is preferably 50 parts by mass or more, more preferably 80 mass % or more, and still more preferably 95 mass % to 100 parts by mass, based on 100 parts by mass of the content of the resin having biomass-derived carbon atoms.

The content of the component (B) in the resin composition according to the exemplary embodiment is preferably 0.1 mass % to 15 mass %, more preferably 0.5 mass % to 10 mass %, and still more preferably 1 mass % to 5 mass %, based on the total mass of the resin composition.

The content of the component (C) in the resin composition according to the exemplary embodiment is preferably 1 mass % to 25 mass %, more preferably 3 mass % to 20 mass %, and still more preferably 5 mass % to 15 mass %, based on the total mass of the resin composition.

The content of the component (D) in the resin composition according to the exemplary embodiment is preferably 1 mass % to 20 mass %, more preferably 3 mass % to 15 mass %, and still more preferably 5 mass % to 10 mass %, based on the total mass of the resin composition.

The content ratio)(C/A^{Bio} of the component (C) to the resin)(A^{Bio} having biomass-derived carbon atoms is preferably 0.03≤(C/A^{Bio})≤0.3, more preferably 0.05≤(C/A^{Bio})≤0.2, and still more preferably 0.07≤(C/A^{Bio})≤0.15.

In addition, the content ratio (C/A) of the component (C) to the component (A) is preferably 0.05≤(C/A)≤0.3, more preferably 0.05≤(C/A)≤0.2, and still more preferably 0.07≤(C/A)≤0.3.

The content ratio (D/A^{Bio}) of the component (D) to the resin (A^{Bio}) having biomass-derived carbon atoms is preferably 0.025 ≤(D/A^{Bio})≤0.3, more preferably 0.05≤(D/A^{Bio})≤0.2, and still more preferably 0.07≤(D/A^{Bio})≤0.1.

In addition, the content ratio (D/A) of the component (D) to the component (A) is preferably 0.025≤(D/A)≤0.3, more preferably 0.05≤(D/A)≤0.2, and still more preferably 0.07≤(D/A)<0.1.

### [Other Components (E)]

The resin composition according to the exemplary embodiment may contain other components (E) (Components (E)). In the case of containing the other components (E), the total content of the other components (E) as a whole is preferably 15 mass % or less, and more preferably 10 mass % or less, based on the total amount of the resin composition.

Examples of other components (E) include: a flame retardant, a compatibilizer, an oxidation inhibitor, a stabilizer, a releasing agent, a light fastness agent, a weathering agent, a colorant, a pigment, a modifier, a drip inhibitor, an antistatic agent, a hydrolysis inhibitor, a filler, a reinforcing agent (such as glass fiber, carbon fiber, talc, clay, mica, glass flake, milled glass, glass beads, crystalline silica, alumina, silicon nitride, aluminum nitride, and boron nitride), an acid acceptor for preventing acetic acid from releasing (oxides such as magnesium oxide and aluminum oxide; metal hydroxides such as magnesium hydroxide, calcium hydroxide, aluminum hydroxide and hydrotalcite; calcium carbonate; talc; or the like), a reactive trapping agent (such as an epoxy compound, an acid anhydride compound, and carbodiimide), or the like.

The content of other components is preferably 0 mass % to 5 mass % based on the total amount of the resin composition. Here, “0 mass %” means not containing other components.

The resin composition according to the exemplary embodiment may contain other resins as other components (E), in addition to the resin having biomass-derived carbon atoms (such as the component (A)), the component (B), the component (C), and the component (D). However, in the case of containing other resins, the content of other resins based on the total amount of the resin composition is preferably 5 mass % or less, and is more preferably less than 1 mass %. It is particularly preferable to not contain other resins (that is, 0 mass %). Examples of other resins include thermoplastic resins known in the related art, and specifically include: a polycarbonate resin; a polypropylene resin; a polyester resin; a polyolefin resin; a polyester carbonate resin; a polyphenylene ether resin; a polyphenylene sulfide resin; a polysulfone resin; a polyether sulfone resin; a polyarylene resin; a polyether imide resin; a polyacetal resin; a polyvinyl acetal resin; a polyketone resin; a polyether ketone resin; a polyether ether ketone resin; a polyaryl ketone resin; a polyether nitrile resin; a liquid crystal resin; a polybenzimidazole resin; a polyparabanic acid resin; a vinyl polymer or copolymer obtained by polymerizing or copolymerizing one or more vinyl monomers selected from the group consisting of an aromatic alkenyl compound, a methacrylic acid ester, an acrylic acid ester, and a vinyl cyanide compound; a diene-aromatic alkenyl compound copolymer; a vinyl cyanide-diene-aromatic alkenyl compound copolymer; an aromatic alkenyl compound-diene-vinyl cyanide-N-phenyl maleimide copolymer; a vinyl cyanide-(ethylene-diene-propylene (EPDM))-aromatic alkenyl compound copolymer; a vinyl chloride resin; a chlorinated vinyl chloride resin; or the like. The above resin may be used alone, or may be used in combination of two or more thereof.

The polyester as other components (E) may contain an aliphatic polyester (el). Examples of the aliphatic polyester (el) include a polymer of hydroxyalkanoate (hydroxyalkanoic acid), a polycondensate of a polycarboxylic acid and a polyhydric alcohol, a ring-opening polycondensate of a cyclic lactam, a polymer in which a lactic acid is polymerized by an ester bond, or the like.

Further, it is also preferable that the resin composition according to the exemplary embodiment contains an oxidation inhibitor or a stabilizer as other components (E). At least one compound (e3) selected from the group consisting of a hindered phenol compound, a tocopherol compound, a tocotrienol compound, a phosphite compound and a hydroxylamine compound is preferably contained as the oxidation inhibitor or the stabilizer.

The compound (e3) may be used alone, or may be used in combination of two or more thereof, and is preferably used in combination of two or more thereof from the viewpoint of obtaining steel ball drop impact strength of the obtained resin molded article.

The form of using two or more of the compound (e3) in combination include a form using two or more of the compound (e3) within the same family in combination (for example, within the hindered phenol compound), or a form using two or more of the compound (e3) within different families in combination (for example, the hindered phenol compound and the tocopherol compound).

The form of using two or more of the compound (e3) in combination is preferably a form using at least one selected from the group consisting of a hindered phenol compound and a hydroxylamine compound and a phosphite compound in combination, and more preferably a form using a hindered phenol compound and a phosphite compound in combination, from the viewpoint of obtaining steel ball drop impact strength of the obtained resin molded article.

The content of the compound (e3) in the resin composition according to the exemplary embodiment is preferably 0.01 mass % to 5 mass %, more preferably 0.05 mass % to 2 mass %, and still more preferably 0.1 mass % to 1 mass %, based on the total mass of the resin composition.

Specific examples of the compound (e3) include hindered phenol compounds such as “Irganox 1010”, “Irganox 245”, and “Irganox 1076” manufactured by BASF, “ADK STAB AO-80”, “ADK STAB AO-60”, “ADK STAB AO-50”, “ADK STAB AO-40”, “ADK STAB AO-30”, “ADK STAB AO-20”, and “ADK STAB AO-330” manufactured by ADEKA Corporation, “Sumilizer GA-80” manufactured by Sumitomo Chemical Co., Ltd., and “Sumilizer GM” and “Sumilizer GS” manufactured by Sumitomo Chemical Co., Ltd.; phosphite compounds such as “Irgafos 38” (bis(2,4-di-t-butyl-6-methylphenyl)-ethyl-phosphite) manufactured by BASF, “Irgafos 168” manufactured by BASF, “Irgafos TNPP” manufactured by BASF, “Irgafos P-EPQ” manufactured by BASF; hydroxylamine compounds such as “Irgastab FS-042” manufactured by BASF; or the like.

Further, specific examples of the tocopherol compound in the compound (e3) include, for example, the following compounds.

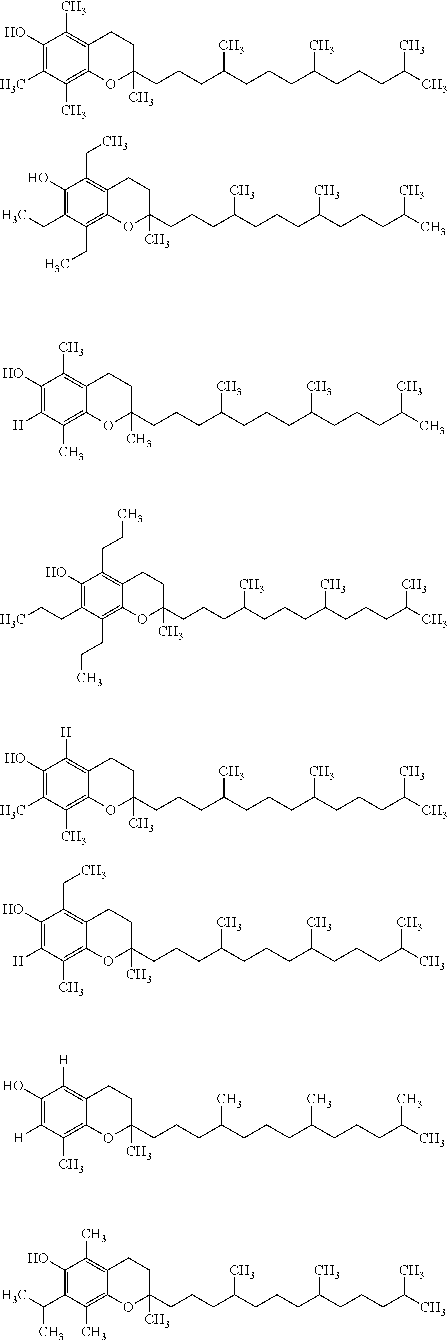

Specific examples of the tocotrienol compound in the compound (e3) include, for example, the following compounds.

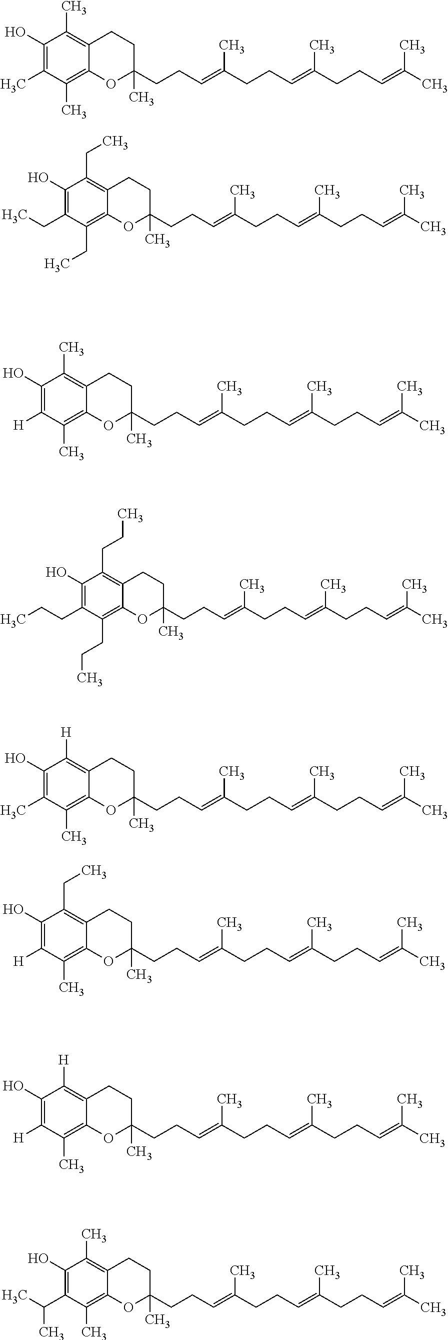

### [Method for Producing Resin Composition]

Examples of the method for producing the resin composition according to the exemplary embodiment, for example, include: a method for mixing and melt-kneading the resin having biomass-derived carbon atoms (such as the component (A)), and, if necessary, the component (B), the component (C), the component (D), and the other components (E); a method for dissolving the resin having biomass-derived carbon atoms (such as the component (A)), and, if necessary, the component (B), the component (C), the component (D), and the other components (E) in a solvent; or the like. Here, the melt-kneading means is not particularly limited, and examples thereof include a twin-screw extruder, a Henschel mixer, a Banbury mixer, a single screw extruder, a multi-screw extruder, a co-kneader or the like.

### <Resin Molded Article>

The resin molded article according to the exemplary embodiment contains the resin composition according to the exemplary embodiment. That is, the resin molded article according to the exemplary embodiment has the same composition as the resin composition according to the exemplary embodiment.

The method for forming the resin molded article according to the exemplary embodiment is preferably injection molding from the viewpoint of obtaining a high degree of freedom of shape. Therefore, the resin molded article according to the exemplary embodiment is preferably an injection molded article obtained by injection molding, from the viewpoint of obtaining a high degree of freedom of shape.

The cylinder temperature during the injection molding of the resin molded article according to the exemplary embodiment is, for example, preferably 160° C. to 280° C., and more preferably 180° C. to 240° C. The mold temperature during the injection molding of the resin molded article according to the exemplary embodiment is, for example, preferably 40° C. to 90° C., and more preferably 40° C. to 60° C.

The injection molding of the resin molded article according to the exemplary embodiment is performed, for example, by using commercial devices such as NEX 500 manufactured by NISSEI PLASTIC INDUSTRIAL CO., LTD., NEX 150 manufactured by NISSEI PLASTIC INDUSTRIAL CO., LTD., NEX 7000 manufactured by NISSEI PLASTIC INDUSTRIAL CO., LTD., PNX 40 manufactured by NISSEI PLASTIC INDUSTRIAL CO., LTD., and SE5OD manufactured by Sumitomo Heavy Industries, Ltd.

The molding method for obtaining the resin molded article according to the exemplary embodiment is not limited to the above injection molding, and injection molding, extrusion molding, blow molding, hot press molding, calender molding, coating molding, cast molding, dipping molding, vacuum molding, transfer molding or the like may also be applied.

The resin molded article according to the exemplary embodiment is suitably used for applications such as electronic and electrical equipment, office equipment, household electric appliances, automotive interior materials, toys, containers, or the like. Specific applications of the resin molded article according to the exemplary embodiment include: casings of electronic/electric devices or household electric appliances; various parts of electronic/electric devices or home electric appliances; interior parts of automobiles; block assembled toys; plastic model kits; CD-ROM or DVD storage cases; dishware; beverage bottles; food trays; wrapping materials; films; sheets; or the like.

### EXAMPLES

Hereinafter, the resin composition and the resin molded article according to the exemplary embodiment will be described in more detail by means of examples. Materials, amounts, ratios, processing procedures, or the like shown in the following examples may be appropriately changed without departing from the gist of the exemplary embodiment. Therefore, the resin composition and the resin molded article according to the exemplary embodiment should not be interpreted restrictively by the following specific examples.

### <Preparation of Each Material>

The following materials are prepared.

### [Resin Having Biomass-Derived Carbon Atom]

### —Cellulose Acylate (A)—

CA1: “CAP 482-20” manufactured by Eastman Chemical Company, cellulose acetate propionate, having a weight-average polymerization degree of 716, an acetyl group degree of substitution of 0.18 and a propionyl group degree of substitution of 2.49.

CA2: “CAP 482-0.5” manufactured by Eastman Chemical Company, cellulose acetate propionate, having a weight-average polymerization degree of 189, an acetyl group degree of substitution of 0.18 and a propionyl group degree of substitution of 2.49.

CA3: “CAP 504-0.2” manufactured by Eastman Chemical Company, cellulose acetate propionate, having a weight-average polymerization degree of 133, an acetyl group degree of substitution of 2.09 and a propionyl group degree of substitution of 0.04.

CA4: “CAB 171-15” manufactured by Eastman Chemical Company, cellulose acetate butyrate, having a weight-average polymerization degree of 754, an acetyl group degree of substitution of 2.07 and a butyryl group degree of substitution of 0.73.

CA7: “L50” manufactured by Daicel Corporation, diacetyl cellulose, having a weight-average polymerization degree of 570.

CA8: “LT-35” manufactured by Daicel Corporation, triacetyl cellulose, having a weight-average polymerization degree of 385.

RC1: “Tenite propionate 360A4000012” manufactured by Eastman Chemical Company, cellulose acetate propionate, having a weight-average polymerization degree of 716, an acetyl group degree of substitution of 0.18 and a propionyl group degree of substitution of 2.49. The product contained dioctyl adipate corresponding to component (C), and the content of cellulose acetate propionate is 88 mass % and the amount of dioctyl adipate is 12 mass %.

RC2: “Treva GC6021” manufactured by Eastman Chemical Company, cellulose acetate propionate, having a weight-average polymerization degree of 716, an acetyl group degree of substitution of 0.18 and a propionyl group degree of substitution of 2.49. The product contains a chemical substance corresponding to the component (D).

CA1 satisfied the following (2), (3) and (4). CA2 satisfied the following (4). (2) When measured by the GPC method using tetrahydrofuran as a solvent, the weight average molecular weight (Mw) in terms of polystyrene is 160,000 to 250,000, a ratio Mn/Mz of a number average molecular weight (Mn) in terms of polystyrene to a Z average molecular weight (Mz) in terms of polystyrene is 0.14 to 0.21, and a ratio Mw/Mz of a weight average molecular weight (Mw) in terms of polystyrene to the Z average molecular weight (Mz) in terms of polystyrene is 0.3 to 0.7. (3) When measured with a Capirograph at a condition of 230° C. according to ISO 11443:1995, a ratio η1/η2 of a viscosity η1 (Pa·s) at a shear rate of 1216 (/sec) to a viscosity η2 (P·s) at a shear rate of 121.6 (/sec) is 0.1 to 0.3. (4) When a small square plate test piece (D11 test piece specified by JIS K7139:2009, 60 mm×60 mm, thickness 1 mm) obtained by injection molding of the CAP is allowed to stand in an atmosphere at a temperature of 65° C. and a relative humidity of 85% for 48 hours, both an expansion coefficient in an MD direction and an expansion coefficient in a TD direction are 0.4% to 0.6%.

### —Resin Having Carbon Atom Derived From Biomass Other Than Cellulose Acylate (A)—

PE1: “Ingeo 3001D” manufactured by Nature Works, polylactic acid.

PE2: “Braskem SGF 4950” manufactured by Braskem, bio-derived polyethylene.

PAl: “Rilsan” manufactured by Arkema S.A., polyamide 11 (a polyamide obtained by ring-opening polycondensation of undecane lactam).

PH1: “Biopol” manufactured by Monsanto Japan, poly(3-hydroxybutyric acid).

### [Ester Compound (B)]

LU1: “stearyl stearate” manufactured by FUJIFILM Wako pure chemical Corporation, stearyl stearate. A compound represented by the General Formula (1), R¹¹ has 17 carbon atoms and 10² has 18 carbon atoms.

LU2: “Ethylene Glycol Distearate” manufactured by FUJIFILM Wako pure chemical Corporation, ethylene glycol distearate. A compound represented by the General Formula (2), R²¹ has 17 carbon atoms and R²² has 17 carbon atoms.

LU3: “glyceryl distearate” manufactured by FUJIFILM Wako pure chemical Corporation, glyceryl distearate. A compound represented by the General Formula (3), R³¹ has 17 carbon atoms and R³² has 17 carbon atoms.

LU4: “Decyl Decanoate” manufactured by Tokyo Chemical Industry, decyl decanoate. A compound represented by the General Formula (1), R¹¹ has 9 carbon atoms and R¹² has 10 carbon atoms.

LU5: “Lauryl Laurate” manufactured by Larodan Fine Chemicals AB, dodecyl dodecanoate. A compound represented by the General Formula (1), R¹¹ has 11 carbon atoms and R¹² has 12 carbon atoms.

LU6: “Docosyl Docosanoate” manufactured by FUJIFILM Wako pure chemical Corporation, docosyl docosanoate. A compound represented by the General Formula (1), R¹¹ has 21 carbon atoms and R¹² has 22 carbon atoms.

### [Plasticizer (C)]

PL1: “NX-2026” manufactured by Cardolite Corporation, cardanol, having a molecular weight of 298 to 305.

PL4: “Ultra LITE 513” manufactured by Cardolite Corporation, gadidyl ether of cardanol, having a molecular weight of 354 to 361.

PL6: “Daifatty 101” manufactured by DAIHACHI CHEMICAL INDUSTRY CO., LTD., an adipate ester-containing compound, having a molecular weight of 326 to 378.

PL7: “DOA” manufactured by Mitsubishi Chemical Corporation, dioctyl adipate, having a molecular weight of 371.

### [Thermoplastic Elastomer (D)]

EL 1: “METABLEN W-600A” manufactured by Mitsubishi Chemical Corporation, core-shell structure polymer (d2), a shell layer polymer obtained by grafting and polymerizing “a methyl methacrylate homopolymer rubber” to “a copolymer rubber of 2-ethylhexyl acrylate and n-butyl acrylate” as a core layer, having an average primary particle diameter of 200 nm.

EL5: “Kane Ace B-564” manufactured by Kaneka Corporation, MBS (methyl methacrylate-butadiene-styrene copolymer) based resin, core-shell structure polymer (d1).

EL6: “Blendex 338” manufactured by Galata Chemicals (Artek), ABS (acrylonitrile-butadiene-styrene copolymer) core shell, core-shell structure polymer (d1).

EL7: “Kraton FG 1924G” manufactured by Kraton Corporation, SEBS (styrene-ethylene-butadiene-styrene copolymer) (d4).

EL8: “Estane ALR 72A” manufactured by Lubrizol Corporation, polyurethane (d5).

EL9: “Hytrel 3078” manufactured by DU PONT-TORAY CO., LTD., aromatic polyester copolymer, polyester (d6).

### [Other Components (E)]

PM1: “DELPET 720V” manufactured by Asahi Kasei, polymethyl methacrylate.

ST1: “Irganox B225” manufactured by BASF, a mixture of pentaerythritol tetrakis(3-(3,5-di-t-butyl-4-Ehydroxyphenyl)propionate) and tris(2,4-di-t-butylphenyl) phosphite.

ST2: “Epoxidized octyl allate” manufactured by Eastman Chemical Company, epoxidized octyl tallate.

### <Preparation of Resin Composition and Injection Molding of Resin Molded Article (Preparation of ISO Multipurpose Dumbbell Test Piece and D2 Test Piece)>

### Examples 1 to 29 and Comparative Examples 1 to 4

Kneading is performed with a twin-screw kneader (TEX 41SS, manufactured by TOSHIBA MACHINE CO., LTD.) at a content ratio of each component and kneading temperatures shown in Table 1 or 2 to obtain a pellet-like resin composition. Using an injection molding machine (NEX500, manufactured by NISSEI PLASTIC INDUSTRIAL CO., LTD.), the obtained pellet-like resin composition is molded into ISO multipurpose dumbbell test pieces (corresponding to ISO 527 tensile test and ISO 178 bending test, test part having a thickness of 4 mm and a width of 10 mm) at an injection peak pressure not exceeding 180 MPa and at molding temperatures and mold temperatures shown in Table 1 or 2.

In addition, the obtained pellet-like resin composition is used to mold a D2 test piece (60 mm×60 mm×thickness 2 mm) with an injection molding machine (NEX500I, manufactured by NISSEI PLASTIC INDUSTRIAL CO., LTD.) at an injection peak pressure not exceeding 180 MPa and at molding temperatures and mold temperatures shown in Table 1 or 2, in accordance with the method specified in ISO 294-3:2002.

### <Measurement of Content of Biomass-Derived Carbon Atom>

Using the obtained pellet-like resin composition, the content of ¹⁴C in the total amount of carbon atoms in the resin composition is measured and the content of the biomass-derived carbon atom is calculated based on the provisions of ASTM D6866:2012. The results are shown in Table 1 or 2.

### <Measurement of Bending Creep Elastic Modulus>

The obtained ISO multipurpose dumbbell test piece is subjected to a test according to ISO 899-2:1993 using a universal testing apparatus (Autograph AG-X plus, manufactured by Shimadzu Corporation) under the conditions of a temperature of 60° C., and a load of 7 MPa or 14 MPa for 1,000 hours, so as to the measure bending creep elastic modulus. The value of F⁷/F¹⁴ is calculated.

The measurement results are shown in Table 1 or 2.

### <Measurement of Puncture Impact Strength (Maximum Impact Force)>

The obtained D2 test piece is subjected to a puncture impact test under the conditions of a striker mass of 5 kg, a falling height of 0.66 m, and a test piece thickness of 2 mm in accordance with ISO 6003:2000, so as to measure the maximum Impact Force (N). The larger the value of the maximum impact force, the better the puncture impact strength.

The measurement results are shown in Table 1 or 2.

<Evaluation on Engaging Force between Parts (Detachability)>

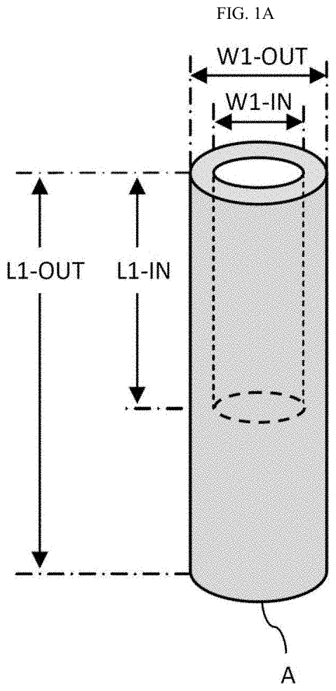

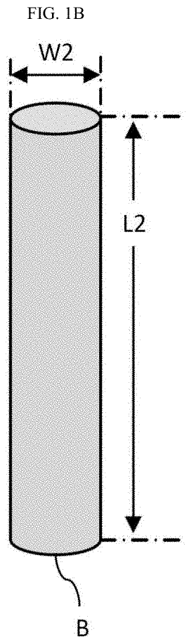

With respect to the obtained pellet-like resin composition, a tubular test piece A (see FIG. 1A) and a cylindrical test piece B (see FIG. 1B) as shown in FIGS. 1A and 1B are separately molded using an injection molding machine (NEX 500, manufactured by NISSEI PLASTIC INDUSTRIAL CO., LTD.) at an injection peak pressure not exceeding 180 MPa and at a molding temperature and a mold temperature shown in Table 1 or 2.

The length of each part in FIGS. 1A and 1B is set as follows.

W1-OUT: 30 mm

W1-IN: 20 mm

L1-OUT: 100 mm

L1-IN: 50 mm

W2: 20 mm

L2: 100 mm

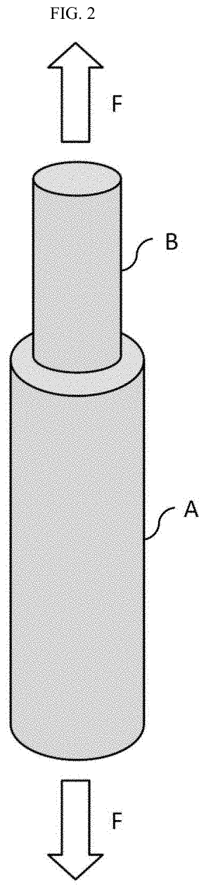

As shown in FIG. 2, the obtained cylindrical test piece B is assembled in the tubular test piece A. Next, by using the force gauge attached universal testing machine (manufactured by Imada, force gauge ZTS/electric measuring stand MX 2), the maximum value of the force applied until the cylindrical test piece B disengaged from the tubular test piece A is measured as the engaging force (detaching force) F (N). The smaller the value of the engaging force F (N), the smaller the force required until the cylindrical test piece B is removed from the tubular test piece A, and the better the detachability.

The evaluation results are shown in Table 1 or 2.

TABLE 1

| | Resin having biomass-derived carbon atoms | | | | | | | | | | | | | | | |
|---|---|---|---|---|---|---|---|---|---|---|---|---|---|---|---|---|
| | | | | | Resin other than | | | | Ester | | | | Thermoplastic | | Other | |
| | Cellulose ester | | | | cellulose ester | | | | compound | | Plasticizer | | elastomer | | components | |
| | (A) | | | | (A) | | Other resin | | (B) | | (C) | | (D) | | (E) | |
| | Type | Cotent | Type | Cotent | Type | Cotent | Type | Cotent | Type | Cotent | Type | Cotent | Type | Cotent | Type | Cotent |
| Example 1 | CA1 | 91.5 | — | — | — | — | — | — | LU1 | 2 | PL1 | 8.5 | EL1 | 7.5 | ST1 | 0.5 |
| Example 2 | CA1 | 91.5 | — | — | PE1 | 5 | PM1 | 5 | LU1 | 2 | PL1 | 8.5 | EL1 | 7.5 | ST1 | 0.5 |
| Example 3 | RC2 | 100 | — | — | — | — | — | — | LU1 | 2 | PL1 | 5 | — | — | ST1 | 0.5 |
| Example 4 | RC2 | 100 | — | — | — | — | PM1 | 15 | LU1 | 2 | — | — | EL1 | 5 | ST1 | 0.5 |
| Example 5 | CA1 | 70 | — | — | PE2 | 30 | — | — | — | — | — | — | — | — | — | — |
| Example 6 | CA1 | 70 | — | — | PA1 | 30 | — | — | LU1 | 2 | — | — | — | — | — | — |
| Example 7 | CA3 | 91.5 | — | — | — | — | — | — | LU1 | 2 | PL1 | 8.5 | EL1 | 7.5 | ST1 | 0.5 |
| Example 8 | CA4 | 91.5 | — | — | — | — | — | — | LU1 | 2 | PL1 | 8.5 | EL1 | 7.5 | ST1 | 0.5 |
| Example 9 | CA7 | 85 | — | — | — | — | — | — | LU1 | 2 | PL1 | 15 | EL1 | 7.5 | ST1 | 0.5 |
| Example 10 | CA8 | 75 | — | — | — | — | — | — | LU1 | 2 | PL1 | 25 | EL1 | 7.5 | ST1 | 0.5 |
| Example 11 | — | — | — | — | PE1 | 100 | | | LU1 | 2 | PL1 | 15 | EL1 | 15 | — | — |
| Example 12 | — | — | — | — | PH1 | 50 | PM1 | 50 | LU1 | 2 | PL1 | 8.5 | EL1 | 7.5 | — | — |
| Example 13 | — | — | — | — | PE2 | 50 | PM1 | 50 | LU1 | 2 | PL1 | 8.5 | EL1 | 7.5 | — | — |
| Example 14 | CA1 | 91.5 | — | — | — | — | — | — | LU1 | 2 | PL2 | 8.5 | EL1 | 7.5 | ST1 | 0.5 |
| Example 15 | CA1 | 91.5 | — | — | — | — | — | — | LU1 | 2 | PL6 | 8.5 | EL1 | 7.5 | ST1 | 0.5 |
| Example 16 | CA1 | 91.5 | — | — | — | — | — | — | LU1 | 2 | PL1 | 8.5 | EL6 | 7.5 | ST1 | 0.5 |
| Example 17 | CA1 | 91.5 | — | — | — | — | — | — | LU1 | 2 | PL1 | 8.5 | EL7 | 7.5 | ST1 | 0.5 |
| Example 18 | CA1 | 91.5 | — | — | — | — | — | — | LU1 | 2 | PL1 | 8.5 | EL8 | 7.5 | ST1 | 0.5 |
| Example 19 | CA1 | 91.5 | — | — | — | — | — | — | LU1 | 2 | PL1 | 8.5 | EL9 | 7.5 | ST1 | 0.5 |
| Comparative | CA1 | 47.5 | CA2 | 47.5 | — | — | — | — | — | — | — | — | EL5 | 4 | ST2 | 1 |
| Example 1 | | | | | | | | | | | | | | | | |
| Comparative | CA1 | 42 | CA2 | 42 | — | — | — | — | — | — | — | — | EL5 | 15 | ST2 | 1 |
| Example 2 | | | | | | | | | | | | | | | | |
| Comparative | CA1 | 88 | — | — | — | — | — | — | — | — | PL7 | 12 | — | — | — | — |
| Example 3 | | | | | | | | | | | | | | | | |

| | | | | Content of | Bending | Bending | | | |
|---|---|---|---|---|---|---|---|---|---|
| | | | | resin having | creep elastic | creep elastic | | | |
| | Kneading | Molding | Mold | biomass-derived | modulus | modulus | | Maximum | Engaging |
| | temperatur | temperatur | temperatur | carbon atoms | (F⁷) | (F¹⁴) | | impact force | force |
| | (° C.) | (° C.) | (° C.) | (mass %) | (MPa) | (MPa) | F⁷/F¹⁴ | (N) | (N) |
| Example 1 | 200 | 200 | 40 | 48 | 1400 | 550 | 2.55 | 3300 | 5 |
| Example 2 | 200 | 200 | 40 | 48 | 1600 | 650 | 2.46 | 2300 | 6 |
| Example 3 | 230 | 230 | 40 | 45 | 1750 | 750 | 2.33 | 2300 | 8 |
| Example 4 | 200 | 200 | 40 | 31 | 1350 | 400 | 3.38 | 1300 | 8 |
| Example 5 | 200 | 200 | 40 | 60 | 1300 | 350 | 3.71 | 1700 | 14 |
| Example 6 | 220 | 220 | 40 | 60 | 1400 | 450 | 3.11 | 1500 | 8 |
| Example 7 | 200 | 200 | 40 | 48 | 1400 | 550 | 2.55 | 3200 | 5 |
| Example 8 | 200 | 200 | 40 | 49 | 1650 | 700 | 2.36 | 3400 | 7 |
| Example 9 | 220 | 220 | 40 | 54 | 1700 | 750 | 2.27 | 1500 | 14 |
| Example 10 | 230 | 230 | 40 | 53 | 1750 | 750 | 2.33 | 1300 | 15 |
| Example 11 | 170 | 170 | 60 | 86 | 1750 | 750 | 2.33 | 1300 | 18 |
| Example 12 | 160 | 160 | 60 | 48 | 1350 | 700 | 1.93 | 1400 | 16 |
| Example 13 | 180 | 180 | 40 | 48 | 1250 | 450 | 2.78 | 1700 | 12 |
| Example 14 | 200 | 200 | 40 | 45 | 1400 | 550 | 2.55 | 3400 | 5 |
| Example 15 | 200 | 200 | 40 | 36 | 1250 | 350 | 3.57 | 3600 | 5 |
| Example 16 | 200 | 200 | 40 | 48 | 1450 | 550 | 2.64 | 3200 | 5 |
| Example 17 | 200 | 200 | 40 | 48 | 1350 | 500 | 2.70 | 3300 | 7 |
| Example 18 | 200 | 200 | 40 | 48 | 1400 | 500 | 2.80 | 3000 | 6 |
| Example 19 | 200 | 200 | 40 | 48 | 1300 | 450 | 2.89 | 3200 | 7 |
| Comparative | 230 | 230 | 40 | 40 | 1700 | 900 | 1.89 | 660 | 30 |
| Example 1 | | | | | | | | | |
| Comparative | 220 | 220 | 40 | 35 | 1300 | 150 | 8.67 | 750 | 32 |
| Example 2 | | | | | | | | | |
| Comparative | 200 | 200 | 40 | 39 | 1050 | 150 | 7.00 | 750 | 28 |
| Example 3 | | | | | | | | | |

TABLE 2

| | Resin having biomass-derived carbon atom | | | | | | | | | | | | | | | |
|---|---|---|---|---|---|---|---|---|---|---|---|---|---|---|---|---|
| | | | | | Resin other than | | | | Ester | | | | Thermoplastic | | Other | |
| | Cellulose ester | | | | cellulose ester | | | | compound | | Plasticizer | | elastomer | | components | |
| | (A) | | | | (A) | | Other resin | | (B) | | (C) | | (D) | | (E) | |
| | Type | Cotent | Type | Cotent | Type | Cotent | Type | Cotent | Type | Cotent | Type | Cotent | Type | Cotent | Type | Cotent |
| Example 20 | CA1 | 91.5 | — | — | — | — | — | — | LU2 | 2 | PL1 | 8.5 | EL1 | 7.5 | ST1 | 0.5 |
| Example 21 | CA1 | 91.5 | — | — | — | — | — | — | LU3 | 2 | PL1 | 8.5 | EL1 | 7.5 | ST1 | 0.5 |
| Example 22 | CA1 | 91.5 | — | — | — | — | — | — | LU4 | 2 | PL1 | 8.5 | EL1 | 7.5 | ST1 | 0.5 |
| Example 23 | CA1 | 91.5 | — | — | — | — | — | — | LU5 | 2 | PL1 | 8.5 | EL1 | 7.5 | ST1 | 0.5 |
| Example 24 | CA1 | 91.5 | — | — | — | — | — | — | LU6 | 2 | PL1 | 8.5 | EL1 | 7.5 | ST1 | 0.5 |
| Example 25 | CA1 | 91.5 | — | — | — | — | — | — | LU1 | 0.3 | PL1 | 8.5 | EL1 | 7.5 | ST1 | 0.5 |
| Example 26 | CA1 | 91.5 | — | — | — | — | — | — | LU1 | 8 | PL1 | 8.5 | EL1 | 7.5 | ST1 | 0.5 |
| Example 27 | CA1 | 91.5 | — | — | — | — | — | — | LU1 | 0.2 | PL1 | 8.5 | EL1 | 7.5 | ST1 | 0.5 |
| Example 28 | CA1 | 91.5 | — | — | — | — | — | — | LU1 | 12 | PL1 | 8.5 | EL1 | 7.5 | ST1 | 0.5 |
| Example 29 | CA1 | 77 | — | — | — | — | — | — | LU1 | 2 | PL6 | 8.5 | EL1 | 7.5 | ST1 | 0.5 |
| Comparative | — | — | — | — | — | — | PM1 | 100 | — | — | PL6 | 10 | EL1 | 10 | ST1 | 0.5 |
| Example 4 | | | | | | | | | | | | | | | | |

| | | | | Content of | Bending | Bending | | | |
|---|---|---|---|---|---|---|---|---|---|
| | | | | resin having | creep elastic | creep elastic | | | |
| | Kneading | Molding | Mold | biomass-derived | modulus | modulus | | Maximum | Engaging |
| | temperatur | temperatur | temperatur | carbon atoms | (F⁷) | (F¹⁴) | | impact force | force |
| | (° C.) | (° C.) | (° C.) | (mass %) | (MPa) | (MPa) | F⁷/F¹⁴ | (N) | (N) |
| Example 20 | 200 | 200 | 40 | 48 | 1350 | 550 | 2.45 | 3300 | 5 |
| Example 21 | 200 | 200 | 40 | 48 | 1400 | 600 | 2.33 | 3250 | 6 |
| Example 22 | 200 | 200 | 40 | 48 | 1400 | 550 | 2.55 | 3200 | 6 |
| Example 23 | 200 | 200 | 40 | 48 | 1350 | 600 | 2.25 | 3250 | 7 |
| Example 24 | 200 | 200 | 40 | 48 | 1400 | 600 | 2.33 | 3150 | 7 |
| Example 25 | 200 | 200 | 40 | 48 | 1400 | 600 | 2.33 | 3300 | 6 |
| Example 26 | 200 | 200 | 40 | 48 | 1350 | 500 | 2.70 | 3300 | 5 |
| Example 27 | 200 | 200 | 40 | 48 | 1400 | 600 | 2.33 | 2950 | 18 |
| Example 28 | 200 | 200 | 40 | 48 | 1300 | 450 | 2.89 | 2800 | 4 |
| Example 29 | 200 | 200 | 40 | 28 | 1200 | 550 | 2.18 | 1700 | 11 |
| Comparative | 260 | 260 | 40 | 0 | 2400 | 200 | 12.00 | 550 | 85 |
| Example 4 | | | | | | | | | |

The units of the content of each component in Tables 1 and 2 are parts by mass.

From the above results, it is understood that the resin composition of Example may obtain a resin molded article excellent in puncture impact strength as compared with the resin composition of Comparative Example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition, comprising a resin having biomass-derived carbon atoms, wherein a ratio (F⁷/F¹⁴) of a bending creep elastic modulus F⁷ to a bending creep elastic modulus F¹⁴ is 1.9 to 6.0, the F⁷ being measured under conditions of a temperature of 60° C. and a load of 7 MPa for 1,000 hours and the F¹⁴ being measured under conditions of a temperature of 60° C. and a load of 14 MPa for 1,000 hours, in accordance with a method specified in ISO 899-2:1993.

2. The resin composition according to claim 1, wherein the content of the biomass-derived carbon atoms in the resin composition defined in ASTM D6866:2012 is 30% or more based on a total amount of carbon atoms in the resin composition.

3. The resin composition according to claim 1, wherein the F⁷ is 1,200 MPa to 1,800 MPa.

4. The resin composition according to claim 1, wherein the F¹⁴ is 200 MPa to 800 MPa.

5. The resin composition according to claim 1, wherein the resin having biomass-derived carbon atoms comprises a cellulose acylate (A).

6. The resin composition according to claim 1, wherein the cellulose acylate (A) is at least one compound selected from the group consisting of cellulose acetate propionate (CAP) and cellulose acetate butyrate (CAB).

7. The resin composition according to claim 1, wherein the content of the cellulose acylate (A) relative to the resin composition is 50 mass % or more.

8. The resin composition according to claim 1, further comprising at least one ester compound (B) selected from the group consisting of a compound represented by the following General Formula (1), a compound represented by the following General Formula (2), a compound represented by the following General Formula (3), a compound represented by the following General Formula (4), and a compound represented by the following General Formula (5), 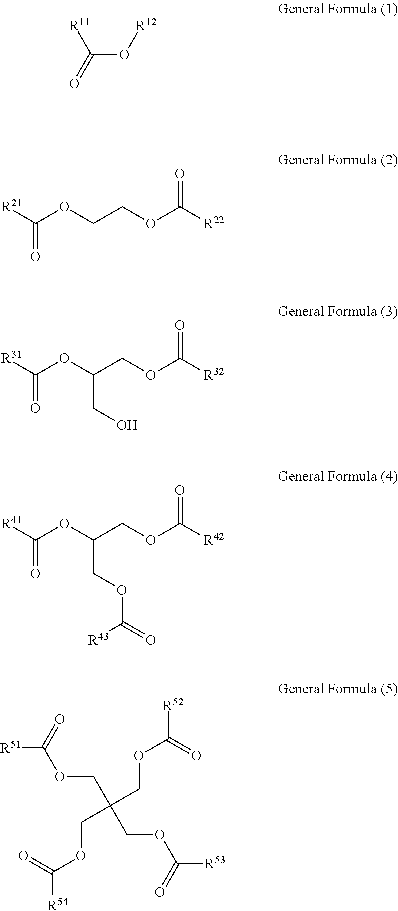
wherein, in the General Formula (1), R¹¹ represents an aliphatic hydrocarbon group having 7 to 28 carbon atoms, and R¹² represents an aliphatic hydrocarbon group having 9 to 28 carbon atoms,
in the General Formula (2), R²¹ and R²² each independently represent an aliphatic hydrocarbon group having 7 to 28 carbon atoms,
in the General Formula (3), R³¹ and R³² each independently represent an aliphatic hydrocarbon group having 7 to 28 carbon atoms,
in the General Formula (4), R⁴¹, R⁴², and R⁴³ each independently represent an aliphatic hydrocarbon group having 7 to 28 carbon atoms, and
in the General Formula (5), R⁵¹, R⁵², R⁵³, and R⁵⁴ each independently represent an aliphatic hydrocarbon group having 7 to 28 carbon atoms.

9. The resin composition according to claim 8, wherein the resin having biomass-derived carbon atoms contains a cellulose acylate (A), and
a mass ratio (B/A) of the ester compound (B) to the cellulose acylate (A) is 0.0025 to 0.1.

10. The resin composition according to claim 8, wherein a mass ratio)(B/A^{Bio} of the ester compound (B) to the resin)(A^{Bio} having biomass-derived carbon atoms is 0.005 to 0.05.

11. The resin composition according to claim 1, further comprising a plasticizer (C).

12. The resin composition according to claim 11, wherein the plasticizer (C) comprises at least one selected from the group consisting of a cardanol compound, a dicarboxylic acid diester, a citrate, a polyether compound having at least one unsaturated bond in the molecule, a polyether ester compound, a glycol benzoate ester, a compound represented by the following General Formula (6) and an epoxidized fatty acid ester, 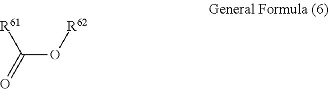
wherein, in the General Formula (6), R⁶¹ represents an aliphatic hydrocarbon group having 7 to 28 carbon atoms, and R⁶² represents an aliphatic hydrocarbon group having 1 to 8 carbon atoms.

13. The resin composition according to claim 11, wherein the plasticizer (C) comprises a cardanol compound.

14. The resin composition according to claim 1, further comprising a thermoplastic elastomer (D).

15. The resin composition according to claim 14, wherein the thermoplastic elastomer (D) contains at least one selected from the group consisting of: a core-shell structure polymer (d1) including a core layer and a shell layer containing an alkyl (meth)acrylate polymer on the surface of the core layer; and an olefin polymer (d2) that is a polymer of an α-olefin and an alkyl (meth)acrylate and contains 60 mass % or more of a structural unit derived from the α-olefin.

16. A resin molded article, comprising the resin composition according to claim 1.

17. The resin molded article according to claim 16, wherein the resin molded article is an injection molded article.

18. The resin composition according to claim 2, wherein the F⁷ is 1,200 MPa to 1,800 MPa.

19. The resin composition according to claim 2, wherein the F¹⁴ is 200 MPa to 800 MPa.

20. The resin composition according to claim 3, wherein the F¹⁴ is 200 MPa to 800 MPa.
